(19) United States
(12) Patent Application Publication
(10) Pub. No.: US 2022/0075059 A1
(43) Pub. Date: Mar. 10, 2022

(54) LEARNING DATA GENERATION DEVICE, LEARNING DATA GENERATION METHOD, LEARNING DATA GENERATION PROGRAM, LEARNING DEVICE, LEARNING METHOD, LEARNING PROGRAM, INFERENCE DEVICE, INFERENCE METHOD, INFERENCE PROGRAM, LEARNING SYSTEM, AND INFERENCE SYSTEM

(71) Applicant: Mitsubishi Electric Corporation, Tokyo (JP)

(72) Inventors: Mamoru DOI, Tokyo (JP); Yumiko KATAYAMA, Tokyo (JP); Kenya SUGIHARA, Tokyo (JP); Mitsuru ASHIZAWA, Tokyo (JP)

(73) Assignee: Mitsubishi Electric Corporation, Tokyo (JP)

(21) Appl. No.: 17/524,933

(22) Filed: Nov. 12, 2021

Related U.S. Application Data
(63) Continuation of application No. PCT/JP2019/024477, filed on Jun. 20, 2019.

(51) Int. Cl. G01S 13/933; G01S 13/90; G06T 7/194; G06N 5/04; G06T 17/00

(52) U.S. Cl. CPC G01S 13/933; G01S 13/9094; G06T 17/00; G06N 5/04; G06T 7/194

(57) ABSTRACT

A learning data generation device includes: a target object image generating unit for simulating radar irradiation to a target object using a 3D model of the target object to generate a target object-simulated radar image that is a simulated radar image of the target object; a background image acquiring unit for acquiring a background image using radar image information generated by the radar device performing radar irradiation; an image combining unit for generating a combined pseudo radar image obtained by combining the background image and the target object-simulated radar image by pasting the target object-simulated radar image generated by the target object image generating unit to a predetermined position in the background image acquired by the background image acquiring unit; and a learning data generating unit for generating learning data that associates combined simulated radar image information indicating the combined pseudo radar image generated by the image combining unit with class information indicating a type of the target object.

### CROSS REFERENCE TO RELATED APPLICATIONS

This application is a Continuation of PCT International Application No. PCT/JP2019/024477, filed on Jun. 20, 2019, which is hereby expressly incorporated by reference into the present application.

### TECHNICAL FIELD

The present invention relates to a learning data generation device, a learning data generation method, a learning data generation program, a learning device, a learning method, a learning program, an inference device, an inference method, an inference program, a learning system, and an inference system.

### BACKGROUND ART

An object present in the sky, the ground, or the like is detected or identified using a radar image generated by performing radar irradiation toward the sky, the ground, or the like.

For example, Patent Literature 1 discloses a target body identification system that inputs a still image of an imaged target body, extracts at least a plurality of different forms of information regarding the target body by an information extraction unit, searches a target candidate from a target information database by a target candidate search unit, and automatically identifies the target body from an image in which the target body is imaged by narrowing down the target candidate while applying a predetermined rule by a target candidate narrowing unit to identify the target body.

In order to detect or identify an object present in the sky, the ground, or the like using a radar image, for example, it is necessary to prepare in advance a database that can be compared with a feature in a radar image of an object appearing in the radar image, such as the target information database described in Patent Literature 1. The database is generated, for example, by collecting in advance a radar image including an object (hereinafter referred to as “target object”) to be detected or identified and extracting a feature of a target object in the collected radar image. In addition, it is also possible to construct an inference device or the like that performs machine learning using the collected radar image as learning data by collecting in advance a radar image including a target object and detects or identifies the target object appearing in the radar image on the basis of a learning result by machine learning.

In order to detect or identify a target object appearing in a radar image with high accuracy, a large number of radar images in which the target object is photographed under different conditions are required in any case such as a case of using a database or a case of performing inference on the basis of a learning result by machine learning.

### CITATION LIST

### Patent Literature

Patent Literature 1: JP 2007-207180A

### SUMMARY OF INVENTION

### Technical Problem

When radar irradiation is performed on the target object at different angles, the features of the image of the target object in the radar image show different features. In addition, since the target object has a nonlinear shape, the features in the radar image of the target object also show different features depending on the difference in the direction of the target object with respect to the irradiation direction of the radar with which the target object is irradiated. Therefore, in order to acquire a large number of radar images in which a target object is photographed under different conditions, it is necessary to collect radar images while changing the direction of the target object, the irradiation direction of the radar, or the like.

However, for example, in a case of generating a radar image by performing radar irradiation from an aircraft, an artificial satellite, or the like like a synthetic aperture radar, it takes a lot of time or effort to collect a large number of radar images in which a target object is photographed under different conditions.

The present invention is intended to solve the above-described problems, and an object thereof is to provide a learning data generation device capable of easily generating learning data used for machine learning for detecting or identifying a target object appearing in a radar image.

### Solution to Problem

A learning data generation device according to the present invention includes: processing circuitry to perform a process of: acquiring target object 3D-model information indicating a 3D model of a target object; generating a target object-simulated radar image that is a simulated radar image of the target object by simulating radar irradiation to the target object using the target object 3D-model information acquired; acquiring radar image information indicating a radar image generated by a radar device performing radar irradiation; cutting out an image region in which an object of the target object is not appearing from the radar image information acquired and acquiring, as a background image, the image region cut out; generating a combined pseudo radar image obtained by combining the background image and the target object-simulated radar image by pasting the target object-simulated radar image generated to a predetermined position in the background image acquired; generating learning data that associates combined simulated radar image information indicating the combined pseudo radar image generated with class information indicating a type of the target object: and outputting the learning data generated.

### Advantageous Effects of Invention

According to the present invention, it is possible to easily generate learning data used for machine learning for detecting or identifying a target object appearing in a radar image.

### BRIEF DESCRIPTION OF DRAWINGS

FIG. 1 is a block diagram illustrating an example of a configuration of a main part of a radar system to which a learning data generation device according to a first embodiment is applied.

FIG. 2 is a block diagram illustrating an example of a configuration of a main part of the learning data generation device according to the first embodiment.

FIG. 3 is a diagram illustrating an example of a 3D model of a target object obtained by visualizing target object 3D-model information by computer graphics.

FIG. 4 is a diagram illustrating an example of a target object-simulated radar image.

FIG. 5 is a diagram illustrating an example of a background image.

FIG. 6 is a diagram illustrating an example of a radar image.

FIG. 7 is a diagram illustrating an example of a combined pseudo radar image.

FIGS. 8A and 8B are diagrams illustrating an example of a hardware configuration of a main part of a learning data generation device 100 according to the first embodiment.

FIG. 9 is a flowchart illustrating an example of processing of the learning data generation device according to the first embodiment.

FIG. 10 is a flowchart illustrating an example of processing of an image combining unit according to the first embodiment.

FIG. 11A is a part of a flowchart illustrating an example of processing of the image combining unit according to the first embodiment.

FIG. 11B is a remaining part of a flowchart illustrating an example of processing of the image combining unit according to the first embodiment.

FIG. 12 is a block diagram illustrating an example of a configuration of a main part of a learning device according to a modification of the first embodiment.

FIG. 13 is a flowchart illustrating an example of processing of a learning device according to the modification of the first embodiment.

FIG. 14 is a block diagram illustrating an example of a configuration of a main part of an inference device according to another modification of the first embodiment.

FIG. 15 is a flowchart illustrating an example of processing of an inference device according to another modification of the first embodiment.

FIG. 16 is a block diagram illustrating an example of a configuration of a main part of a radar system to which a learning data generation device according to a second embodiment is applied.

FIG. 17 is a block diagram illustrating an example of a configuration of a main part of the learning data generation device according to the second embodiment.

FIG. 18 is a diagram illustrating an example of a shadow pseudo radar image.

FIG. 19 is a diagram illustrating an example of a combined pseudo radar image.

FIG. 20 is a diagram illustrating an example of a noise image.

FIG. 21 is a flowchart illustrating an example of processing of the learning data generation device according to the second embodiment.

FIG. 22A is a part of a flowchart illustrating an example of processing of an image combining unit according to the second embodiment.

FIG. 22B is a remaining part of a flowchart illustrating an example of processing of the image combining unit according to the second embodiment.

FIG. 23A is a part of a flowchart illustrating an example of processing of the image combining unit according to the second embodiment.

FIG. 23B is a remaining part of a flowchart illustrating an example of processing of the image combining unit according to the second embodiment.

FIG. 24 is a block diagram illustrating an example of a configuration of a main part of a radar system to which a learning data generation device according to a third embodiment is applied.

FIG. 25 is a block diagram illustrating an example of a configuration of a main part of the learning data generation device according to the third embodiment.

FIG. 26 is a flowchart illustrating an example of processing of the learning data generation device according to the third embodiment.

### DESCRIPTION OF EMBODIMENTS

Hereinafter, embodiments of the present invention will be described in detail with reference to the drawings.

### First Embodiment

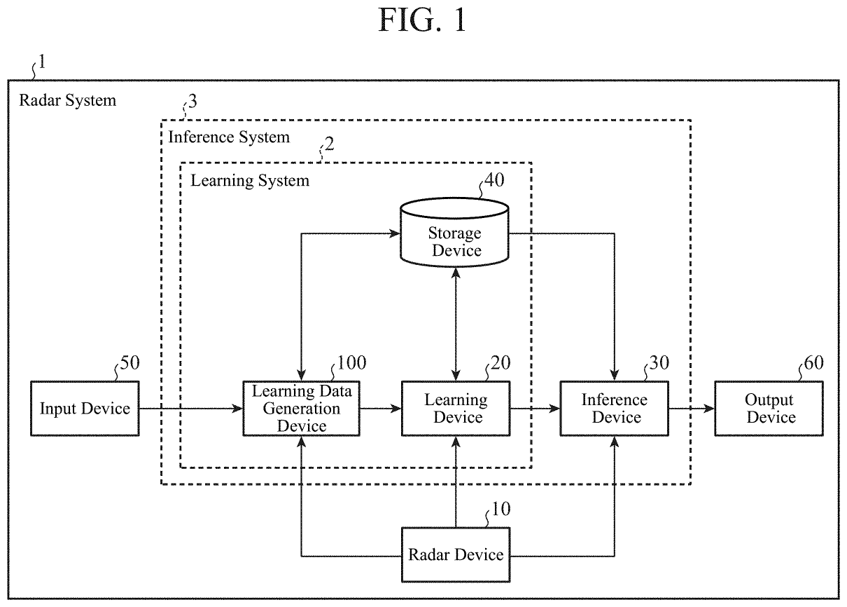

A learning data generation device 100 according to a first embodiment will be described with reference to FIGS. 1 to 11.

FIG. 1 is a block diagram illustrating an example of a configuration of a main part of a radar system 1 to which the learning data generation device 100 according to the first embodiment is applied.

The radar system 1 includes a learning data generation device 100, a radar device 10, a learning device 20, an inference device 30, a storage device 40, an input device 50, and an output device 60.

Note that the configuration including the learning data generation device 100, the learning device 20, and the storage device 40 operates as a learning system 2.

In addition, a configuration including the learning data generation device 100, the learning device 20, the inference device 30, and the storage device 40 operates as an inference system 3.

The storage device 40 is a device for storing electronic information having a storage medium such as a solid state drive (SSD) or a hard disk drive (HDD). The storage device 40 is connected to the learning data generation device 100, the radar device 10, the learning device 20, the inference device 30, or the like via a wired communication unit or a wireless communication unit.

The radar device 10 emits a radar signal, receives a reflected signal of the emitted radar signal as a reflected radar signal, generates a radar image corresponding to the received reflected radar signal, and outputs radar image information indicating the generated radar image.

Specifically, the radar device 10 outputs the radar image information to the learning data generation device 100 or the storage device 40, and the inference device 30.

The radar device 10 may output the radar image information to the learning device 20 in addition to the learning data generation device 100 or the storage device 40, and the inference device 30.

In the radar image information output from the radar device 10, for example, each pixel value of the radar image indicated by the radar image information indicates the intensity of the reflected radar signal. The radar image information may include phase information.

Furthermore, for example, in the radar image information output from the radar device 10, the intensity of the reflected radar signal may be converted into a logarithmic scale in each pixel value of the radar image indicated by the radar image information, and further the intensity of the reflected radar signal after conversion into the logarithmic scale may be normalized so that the maximum value is 1 and the minimum value is 0. The radar image indicated by the radar image information thus normalized can be visually recognized as a grayscale image in which the maximum value is 1 and the minimum value is 0.

Hereinafter, description will be given on the assumption that each pixel value of the radar image indicated by the radar image information indicates the intensity of the reflected radar signal in the radar image information output from the radar device 10.

The learning data generation device 100 generates learning data used when performing machine learning for detecting or identifying a target object appearing in a radar image, and outputs the generated learning data to the learning device 20 or the storage device 40. Details of the learning data generation device 100 will be described later.

The learning device 20 acquires learning data, and performs machine learning for detecting or identifying a target object appearing in a radar image indicated by radar image information output from the radar device 10, using the acquired learning data. The learning device 20 acquires the learning data used to perform machine learning output from the learning data generation device 100 from the learning data generation device 100 or the storage device 40. In addition to acquiring the learning data used to perform machine learning from the learning data generation device 100 or the storage device 40, the learning device 20 may acquire the radar image information output from the radar device 10 from the radar device 10 or the storage device 40 as the learning data. The learning device 20 outputs learned model information indicating a learned model corresponding to a learning result by machine learning for detecting or identifying a target object appearing in a radar image to the inference device 30 or the storage device 40. The learned model indicated by the learned model information output from the learning device 20 is a neural network or the like having an input layer, an intermediate layer, an output layer, and the like.

The inference device 30 acquires the radar image information output from the radar device 10 from the radar device 10 or the storage device 40, and acquires the learned model information output from the learning device 20 from the learning device 20 or the storage device 40. The inference device 30 detects or identifies the target object appearing in the radar image indicated by the acquired radar image information using the learned model indicated by the acquired learned model information. The inference device 30 outputs result information indicating the detection result of detecting the target object, the identified identification result, or the like to the output device 60.

The input device 50 is, for example, an operation input device such as a keyboard or a mouse. The input device 50 receives an operation from the user, and outputs an operation signal corresponding to the operation of the user to the learning data generation device 100 via a wired communication unit or a wireless communication unit.

The output device 60 is, for example, a display output device such as a display. The output device 60 is not limited to the display output device, and may be an illumination device such as a lamp, an audio output device such as a speaker, or the like. The output device 60 acquires the result information output from the inference device 30, and outputs the acquired result information by light, voice, or the like in a state where a user can recognize it.

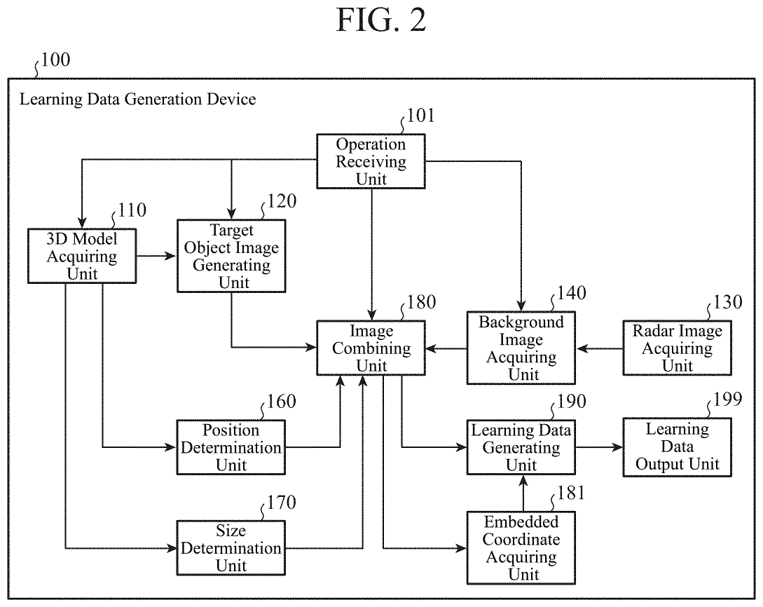

A configuration of a main part of the learning data generation device 100 according to the first embodiment will be described with reference to FIG. 2.

FIG. 2 is a block diagram illustrating an example of a configuration of the main part of the learning data generation device 100 according to the first embodiment.

The learning data generation device 100 includes an operation receiving unit 101, a 3D model acquiring unit 110, a target object image generating unit 120, a radar image acquiring unit 130, a background image acquiring unit 140, an image combining unit 180, a learning data generating unit 190, and a learning data output unit 199.

In addition to the above-described configuration, the learning data generation device 100 may include a position determination unit 160, a size determination unit 170, and an embedded coordinate acquiring unit 181.

The learning data generation device 100 according to the first embodiment will be described as including the position determination unit 160 and the size determination unit 170 as illustrated in FIG. 2.

The operation receiving unit 101 receives an operation signal output from the input device 50, converts the received operation signal into operation information corresponding to the operation signal, and outputs the converted operation information to the 3D model acquiring unit 110, the target object image generating unit 120, the background image acquiring unit 140, the image combining unit 180, or the like.

The 3D model acquiring unit 110 acquires target object 3D-model information indicating the 3D model of the target object. The 3D model acquiring unit 110 acquires the target object 3D-model information by reading the target object 3D-model information from the storage device 40, for example. The 3D model acquiring unit 110 may hold the target object 3D-model information in advance. Furthermore, the 3D model acquiring unit 110 may acquire, for example, the target object 3D-model information on the basis of the operation information output from the operation receiving unit 101. More specifically, for example, the user inputs the target object 3D-model information by operating the input device 50. The operation receiving unit 101 receives an operation signal indicating the target object 3D-model information, converts the operation signal into operation information corresponding to the operation signal, and outputs the converted operation information to the 3D model acquiring unit 110. The 3D model acquiring unit 110 acquires the target object 3D-model information by acquiring the operation information from the operation receiving unit 101.

The target object 3D-model information acquired by the 3D model acquiring unit 110 is structural information indicating the structure of the target object such as a shape or size of the target object. The target object 3D-model information may include, in addition to the structural information, composition information or the like indicating a material of a member constituting the target object or a composition of the target object such as surface roughness.

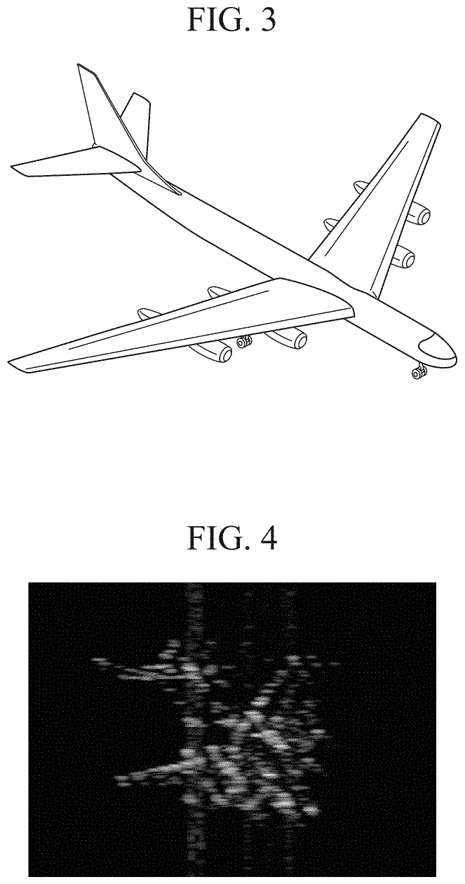

FIG. 3 is a diagram illustrating an example of a 3D model of a target object obtained by visualizing target object 3D-model information acquired by the 3D model acquiring unit 110 by computer graphics.

As illustrated in FIG. 3, the target object is an aircraft. The target object is not limited to an aircraft, and may be an object such as an automobile or a ship.

The target object image generating unit 120 simulates radar irradiation to a target object using the target object 3D-model information acquired by the 3D model acquiring unit 110, and generates a simulated radar image (hereinafter, referred to as a “target object-simulated radar image”) of the target object.

Specifically, for example, the target object image generating unit 120 acquires parameters such as the irradiation direction of the radar with respect to the target object or the direction of the target object with respect to the irradiation direction of the radar, the distance between the emission position of the radar irradiation to the target object and the target object, or the scattering rate of the radar between the emission position of the radar irradiation to the target object and the target object when performing the radar irradiation to the target object.

For example, the target object image generating unit 120 acquires the parameter on the basis of the operation information output from the operation receiving unit 101. More specifically, for example, the user inputs the parameter by operating the input device 50. The operation receiving unit 101 receives the operation signal indicating the parameter, converts the operation signal into operation information corresponding to the operation signal, and outputs the converted operation information to the target object image generating unit 120. The target object image generating unit 120 acquires the parameter by acquiring the operation information from the operation receiving unit 101. The target object image generating unit 120 may hold the parameter in advance or may acquire the parameter by reading it from the storage device 40.

The target object image generating unit 120 simulates radar irradiation to the target object and generates a target object-simulated radar image on the basis of the acquired parameter and the target object 3D-model information acquired by the 3D model acquiring unit 110.

FIG. 4 is a diagram illustrating an example of a target object-simulated radar image that the target object image generating unit 120 has generated by simulating radar irradiation to a target object using the target object 3D-model information indicating the 3D model of the target object illustrated in FIG. 3. Note that FIG. 4 visualizes the target object-simulated radar image as a grayscale image by converting the intensity of the reflected radar signal of the simulated radar irradiation into a logarithmic scale in each pixel value of the target object-simulated radar image, and further normalizing the intensity of the reflected radar signal converted into the logarithmic scale so as to have a value between 0 and 1.

The radar image acquiring unit 130 acquires radar image information indicating a radar image generated by the radar device 10 performing radar irradiation. Specifically, the radar image acquiring unit 130 acquires the radar image information output from the radar device 10 from the radar device 10 or the storage device 40.

The background image acquiring unit 140 acquires a background image using the radar image information acquired by the radar image acquiring unit 130.

Specifically, for example, the background image acquiring unit 140 acquires, as a background image, a radar image in which an object such as a target object is not included in a radar image indicated by the radar image information acquired by the radar image acquiring unit 130.

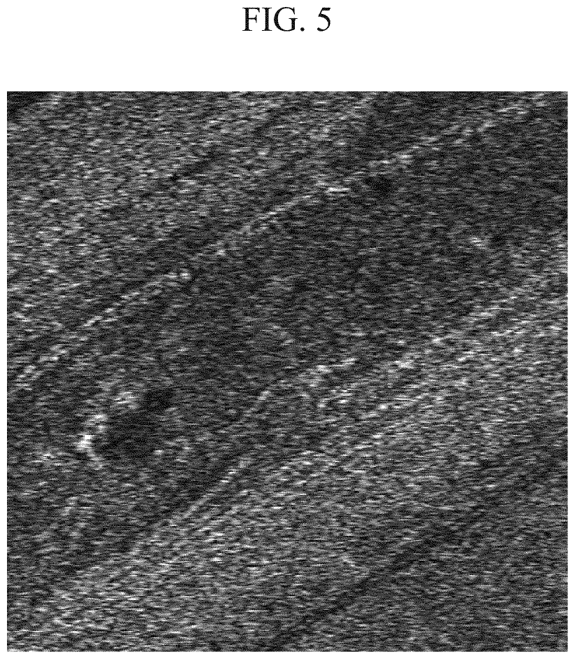

FIG. 5 is a diagram illustrating an example of a background image acquired by the background image acquiring unit 140. Note that in FIG. 5, in each pixel value of the background image, the intensity of the reflected radar signal is converted into a logarithmic scale, the intensity of the reflected radar signal converted into the logarithmic scale is normalized so as to have a value between 0 and 1, and thereby the background image is visualized as a grayscale image.

In addition, for example, the radar image acquiring unit 130 may acquire radar image information indicating a radar image in which a wide area is photographed, and the background image acquiring unit 140 may cut out a partial image region of the radar image in which a wide area is photographed indicated by the radar image information acquired by the radar image acquiring unit 130 and acquire the cut out image region as a background image. More specifically, for example, the background image acquiring unit 140 cuts out an image region in which an object such as a target object is not included from a radar image in which a wide area is photographed indicated by the radar image information acquired by the radar image acquiring unit 130, and acquires the cut out image region as a background image.

For example, the background image acquiring unit 140 determines an image region to be cut out from a radar image in which a wide area is photographed indicated by the radar image information acquired by the radar image acquiring unit 130 on the basis of the operation information output from the operation receiving unit 101. More specifically, for example, the user inputs an image region to be cut out by operating the input device 50. The operation receiving unit 101 receives an operation signal indicating an image region to be cut out, converts the operation signal into operation information corresponding to the operation signal, and outputs the converted operation information to the background image acquiring unit 140. The background image acquiring unit 140 acquires the operation information from the operation receiving unit 101 to determine an image region to be cut out.

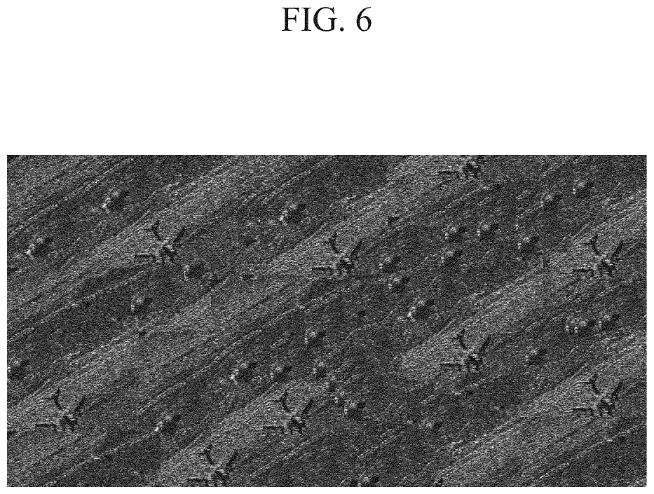

FIG. 6 is a diagram illustrating an example of a radar image in which a wide area is photographed indicated by radar image information acquired by the radar image acquiring unit 130. Note that in FIG. 6, in each pixel value of the radar image, the intensity of the reflected radar signal is converted into a logarithmic scale, further the intensity of the reflected radar signal converted into the logarithmic scale is normalized so as to have a value between 0 and 1, and thereby the radar image is visualized as a grayscale image.

The background image acquiring unit 140 cuts out an image region in which an object such as a target object as shown in FIG. 5 is not included in the radar image in which a wide area is photographed as shown in FIG. 6, and acquires the cut out image region as a background image.

The image combining unit 180 pastes the target object-simulated radar image generated by the target object image generating unit 120 to a predetermined position in the background image acquired by the background image acquiring unit 140 to generate a combined pseudo radar image obtained by combining the background image and the target object-simulated radar image.

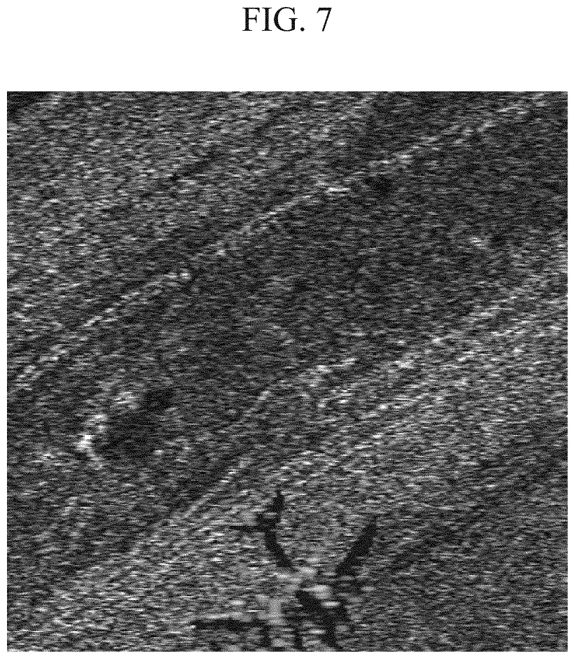

FIG. 7 is a diagram illustrating an example of a combined pseudo radar image generated by the image combining unit 180. Note that FIG. 7 visualizes the combined pseudo radar image as a grayscale image by converting the intensity of the reflected radar signal and the intensity of the reflected radar signal of the simulated radar irradiation into a logarithmic scale in each pixel value of the combined pseudo radar image, and further normalizing the intensity of the reflected radar signal converted into the logarithmic scale and the intensity of the reflected radar signal converted into the logarithmic scale in the simulated radar irradiation so as to have values between 0 and 1.

For example, the image combining unit 180 acquires a position in the background image to which the target object-simulated radar image is pasted on the basis of the operation information output from the operation receiving unit 101. More specifically, for example, the user inputs the position in the background image to which the target object-simulated radar image is pasted by operating the input device 50. The operation receiving unit 101 receives an operation signal indicating a position in the background image to which the target object-simulated radar image is pasted, converts the operation signal into operation information corresponding to the operation signal, and outputs the converted operation information to the image combining unit 180. The image combining unit 180 acquires the position in the background image to which the target object-simulated radar image is pasted by acquiring the operation information from the operation receiving unit 101.

Furthermore, for example, in a case where the learning data generation device 100 includes the position determination unit 160, the position in the background image to which the target object-simulated radar image is pasted may be determined by the position determination unit 160.

The position determination unit 160 determines a position at which the target object-simulated radar image generated by the target object image generating unit 120 is pasted to the background image on the basis of the 3D model of the target object indicated by the target object 3D-model information and the irradiation direction of the simulated radar irradiation to the target object when the target object image generating unit 120 simulates the radar irradiation to the target object using the target object 3D-model information acquired by the 3D model acquiring unit 110.

In addition, the image combining unit 180 may change the size of the target object-simulated radar image generated by the target object image generating unit 120 to a predetermined size, and paste the target object-simulated radar image after the size change to a predetermined position in the background image acquired by the background image acquiring unit 140 to generate a combined pseudo radar image obtained by combining the background image and the target object-simulated radar image.

For example, in a case where the learning data generation device 100 includes the size determination unit 170, the changed size of the target object-simulated radar image is determined by the size determination unit 170.

The size determination unit 170 determines the size of pasting the target object-simulated radar image generated by the target object image generating unit 120 to the background image on the basis of the ratio between the distance between the 3D model of the target object indicated by the target object 3D-model information and the emission position of the simulated radar irradiation to the target object when the target object image generating unit 120 simulates the radar irradiation to the target object using the target object 3D-model information acquired by the 3D model acquiring unit 110 and the distance between the assumed target object and the emission position of the radar irradiation in the radar device 10 when the radar device 10 performs actual radar irradiation.

The learning data generating unit 190 generates learning data that associates combined simulated radar image information indicating the combined pseudo radar image generated by the image combining unit 180 with class information indicating the type of the target object. The learning data generating unit 190 may generate learning data that associates the position at which the image combining unit 180 has pasted the target object-simulated radar image to the background image with the class information indicating the type of the target object.

More specifically, for example, when the learning data generation device 100 includes the embedded coordinate acquiring unit 181, the learning data generating unit 190 may acquire, by the embedded coordinate acquiring unit 181, information indicating coordinates of a pixel in a background image in which the image combining unit 180 has replaced a pixel value of the background image with a pixel value of the target object-simulated radar image, and generate learning data by associating the acquired information indicating the image with the class information indicating a type of the target object.

The embedded coordinate acquiring unit 181 acquires, from the image combining unit 180, information indicating coordinates of pixels in the background image in which the image combining unit 180 has replaced the pixel value of the background image with the pixel value of the target object-simulated radar image. The embedded coordinate acquiring unit 181 outputs the acquired information to the learning data generating unit 190.

The learning data output unit 199 outputs the learning data generated by the learning data generating unit 190.

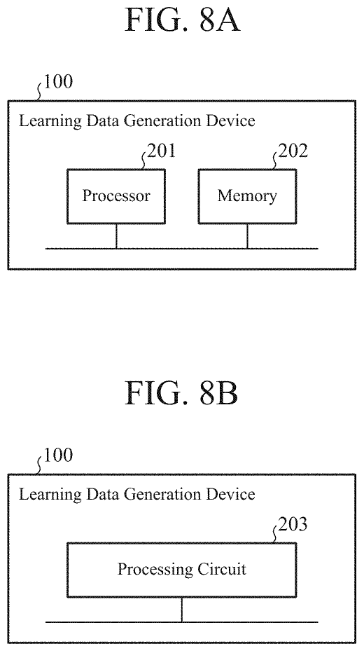

A hardware configuration of a main part of the learning data generation device 100 according to the first embodiment will be described with reference to FIGS. 8A and 8B.

FIGS. 8A and 8B are diagrams illustrating an example of a hardware configuration of a main part of the learning data generation device 100 according to the first embodiment.

As illustrated in FIG. 8A, the learning data generation device 100 includes a computer, and the computer has a processor 201 and a memory 202. The memory 202 stores programs for causing the computer to function as the operation receiving unit 101, the 3D model acquiring unit 110, the target object image generating unit 120, a radar image acquiring unit 130, the background image acquiring unit 140, the position determination unit 160, the size determination unit 170, the image combining unit 180, the embedded coordinate acquiring unit 181, the learning data generating unit 190, and the learning data output unit 199. The processor 201 reads and executes the program stored in the memory 202 to implement the operation receiving unit 101, the 3D model acquiring unit 110, the target object image generating unit 120, the radar image acquiring unit 130, the background image acquiring unit 140, the position determination unit 160, the size determination unit 170, the image combining unit 180, the embedded coordinate acquiring unit 181, the learning data generating unit 190, and the learning data output unit 199.

In addition, as illustrated in FIG. 8B, the learning data generation device 100 may include a processing circuit 203. In this case, the functions of the operation receiving unit 101, the 3D model acquiring unit 110, the target object image generating unit 120, the radar image acquiring unit 130, the background image acquiring unit 140, the position determination unit 160, the size determination unit 170, the image combining unit 180, the embedded coordinate acquiring unit 181, the learning data generating unit 190, and the learning data output unit 199 may be implemented by the processing circuit 203.

Furthermore, the learning data generation device 10 may include the processor 201, the memory 202, and the processing circuit 203 (not illustrated). In this case, some of the functions of the operation receiving unit 101, the 3D model acquiring unit 110, the target object image generating unit 120, the radar image acquiring unit 130, the background image acquiring unit 140, the position determination unit 160, the size determination unit 170, the image combining unit 180, the embedded coordinate acquiring unit 181, the learning data generating unit 190, and the learning data output unit 199 may be implemented by the processor 201 and the memory 202, and the remaining functions may be implemented by the processing circuit 203.

The processor 201 uses, for example, at least one of a Central Processing Unit (CPU), a Graphics Processing Unit (GPU), a microprocessor, a microcontroller, or a Digital Signal Processor (DSP).

The memory 202 uses, for example, a semiconductor memory or a magnetic disk. More specifically, the memory 202 uses a random access memory (RAM), a read only memory (ROM), a flash memory, an erasable programmable read only memory (EPROM), an electrically erasable programmable read-only memory (EEPROM), an SSD, an HDD, or the like.

The processing circuit 203 uses, for example, at least one of an Application Specific Integrated Circuit (ASIC), a Programmable Logic Device (PLD), a Field-Programmable Gate Array (FPGA), a System-on-a-Chip (SoC), or a system Large-Scale Integration (LSI).

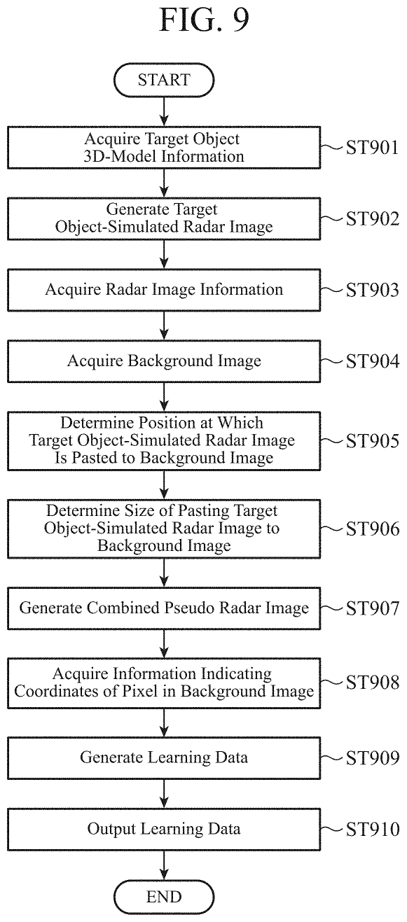

The operation of the learning data generation device 100 according to the first embodiment will be described with reference to FIG. 9.

FIG. 9 is a flowchart illustrating an example of processing of the learning data generation device 100 according to the first embodiment.

For example, the learning data generation device 100 repeatedly executes the processing of the flowchart.

First, in step ST901, the 3D model acquiring unit 110 acquires target object 3D-model information.

Next, in step ST902, the target object image generating unit 120 generates a target object-simulated radar image.

Next, in step ST903, the radar image acquiring unit 130 acquires radar image information.

Next, in step ST904, the background image acquiring unit 140 acquires a background image.

Next, in step ST905, the position determination unit 160 determines a position at which the target object-simulated radar image is pasted to the background image.

Next, in step ST906, the size determination unit 170 determines the size of pasting the target object-simulated radar image to the background image.

Next, in step ST907, the image combining unit 180 generates a combined pseudo radar image.

Next, in step ST908, the embedded coordinate acquiring unit 181 acquires information indicating coordinates of a pixel in the background image in which the image combining unit 180 has replaced the pixel value of the background image with the pixel value of the target object-simulated radar image.

Next, in step ST909, the learning data generating unit 190 generates learning data.

Next, in step ST910, the learning data output unit 199 outputs the learning data.

After executing the processing of step ST910, the learning data generation device 100 ends the processing of the flowchart, returns to the processing of step ST901, and repeatedly executes the processing of the flowchart.

Note that, in the processing of the flowchart, if the processing of step ST901 precedes the processing of step ST902, the processing of step ST903 precedes the processing of step ST904, and the processing from step ST901 to step ST904 precedes step ST905, the order of the processing from step ST901 to step ST904 is arbitrary.

Furthermore, in a case where it is not necessary to change the target object 3D-model information when repeatedly executing the processing of the flowchart, the processing of step ST901 can be omitted.

Furthermore, in a case where it is not necessary to change the radar image information when repeatedly executing the processing of the flowchart, the processing of step ST903 can be omitted.

A method in which the image combining unit 180 generates a combined pseudo radar image by combining the background image and the target object-simulated radar image will be described.

A first method in which the image combining unit 180 generates a combined pseudo radar image will be described.

A method for generating a combined pseudo radar image by combining the background image and the target object-simulated radar image in the image combining unit 180 will be described.

For example, the image combining unit 180 generates a combined pseudo radar image by combining the background image and the target object-simulated radar image by adding each pixel value of the target object-simulated radar image and a pixel value at a position of a pixel corresponding to a position of each pixel of the target object-simulated radar image in the background image for combining the target object-simulated radar image.

A second method in which the image combining unit 180 generates a combined pseudo radar image will be described.

In a case where the target object image generating unit 120 generates the target object-simulated radar image as the grayscale image normalized so that each pixel value of the target object-simulated radar image has a value between 0 and 1 or the like, and the background image acquiring unit 140 acquires the background image as the grayscale image normalized so that each pixel value of the background image has a value between 0 and 1 or the like, the image combining unit 180 may, for example, generate the combined pseudo radar image by combining the background image and the target object-simulated radar image, as described below.

In this case, for example, the image combining unit 180 compares each pixel value of the target object-simulated radar image with a pixel value at a position of a pixel corresponding to a position of each pixel of the target object-simulated radar image in the background image for combining the target object-simulated radar image, and for a pixel whose pixel value of the target object-simulated radar image is larger than the pixel value of the background image, replaces the pixel value of the background image with the pixel value of the target object-simulated radar image, thereby combining the background image and the target object-simulated radar image to generate a combined pseudo radar image.

The first and second methods in which the image combining unit 180 generates the combined pseudo radar image are merely examples, and the method in which the image combining unit 180 generates the combined pseudo radar image by combining the background image and the target object-simulated radar image is not limited to the first and second methods described above.

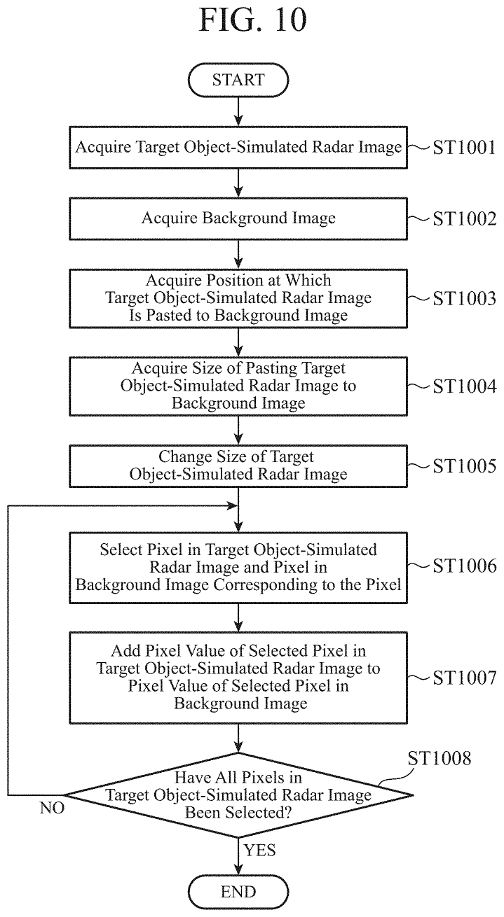

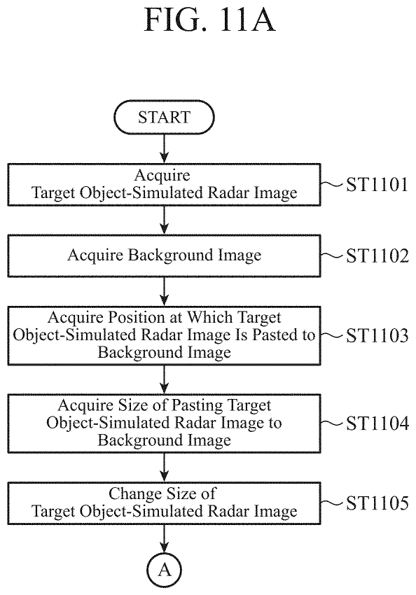

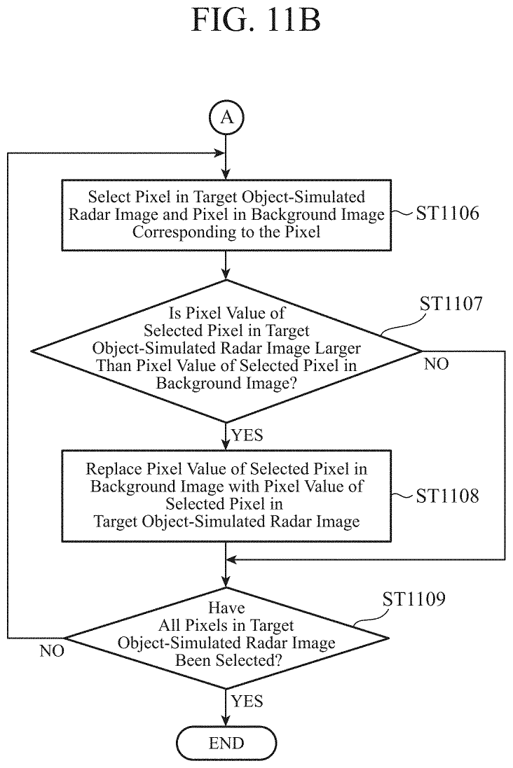

The operation of the image combining unit 180 according to the first embodiment will be described with reference to FIGS. 10 and 11.

FIG. 10 is a flowchart illustrating an example of processing of the image combining unit 180 according to the first embodiment. That is, FIG. 10 is a flowchart illustrating processing of step ST907 illustrated in FIG. 9. The flowchart illustrated in FIG. 10 illustrates the operation of the image combining unit 180 in the first method in which the image combining unit 180 generates a combined pseudo radar image.

First, in step ST1001, the image combining unit 180 acquires a target object-simulated radar image.

Next, in step ST1002, the image combining unit 180 acquires a background image.

Next, in step ST1003, the image combining unit 180 acquires a position at which the target object-simulated radar image is pasted to the background image.

Next, in step ST1004, the image combining unit 180 acquires the size of pasting the target object-simulated radar image to the background image.

Next, in step ST1005, the image combining unit 180 changes the size of the target object-simulated radar image on the basis of the size of pasting the target object-simulated radar image to the background image.

Next, in step ST1006, the image combining unit 180 selects a pixel in the target object-simulated radar image and a pixel in the background image corresponding to the pixel.

Next, in step ST1007, the image combining unit 180 adds the pixel value of the selected pixel in the target object-simulated radar image to the pixel value of the selected pixel in the background image.

Next, in step ST1008, the image combining unit 180 determines whether or not all the pixels in the target object-simulated radar image have been selected.

In step ST1008, when the image combining unit 180 determines that not all the pixels in the target object-simulated radar image have been selected, the image combining unit 180 returns to the processing of step ST1006 and repeatedly executes the processing from step ST1006 to step ST1008 until the image combining unit 180 determines that all the pixels in the target object-simulated radar image have been selected.

In step ST1008, when the image combining unit 180 determines that all the pixels in the target object-simulated radar image have been selected, the image combining unit 180 ends the processing of the flowchart.

Note that, in the processing of the flowchart, the order of the processing from step ST1001 to step ST1004 is arbitrary.

Furthermore, when generating the combined pseudo radar image, the learning data generation device 100 may generate the combined pseudo radar image by combining the background image and the target object-simulated radar image with transparency of the target object-simulated radar image at a predetermined ratio by alpha blending or the like. Specifically, for example, when the image combining unit 180 adds the pixel value of the pixel in the target object-simulated radar image to the pixel value of the pixel in the background image in the processing of step ST1007, the image combining unit 180 may multiply the pixel value of the pixel in the target object-simulated radar image by, for example, any value between 0 and 1, and add the multiplied pixel value to the pixel value of the pixel in the background image.

In the combined pseudo radar image generated in this way, the region to which the target object-simulated radar image is pasted in the combined pseudo radar image becomes unclear, and the learning data generation device 100 can generate learning data having a combined pseudo radar image similar to an actual radar image generated by the radar device 10 performing radar irradiation.

FIG. 11 is a flowchart illustrating an example of processing of the image combining unit 180 according to the first embodiment. That is, FIG. 11 is a flowchart illustrating processing of step ST907 illustrated in FIG. 9. The flowchart illustrated in FIG. 11 illustrates the operation of the image combining unit 180 in the second method in which the image combining unit 180 generates a combined pseudo radar image. Note that FIG. 11A illustrates a part of the processing flow of the image combining unit 180 according to the first embodiment, and FIG. 11B illustrates the rest of the processing flow of the image combining unit 180 according to the first embodiment.

First, in step ST1101, the image combining unit 180 acquires a target object-simulated radar image.

Next, in step ST1102, the image combining unit 180 acquires a background image.

Next, in step ST1103, the image combining unit 180 acquires a position at which the target object-simulated radar image is pasted to the background image.

Next, in step ST1104, the image combining unit 180 acquires the size of pasting the target object-simulated radar image to the background image.

Next, in step ST1105, the image combining unit 180 changes the size of the target object-simulated radar image on the basis of the size of pasting the target object-simulated radar image to the background image.

Next, in step ST1106, the image combining unit 180 selects a pixel in the target object-simulated radar image and a pixel in the background image corresponding to the pixel.

Next, in step ST1107, the image combining unit 180 determines whether or not the pixel value of the selected pixel in the target object-simulated radar image is larger than the pixel value of the selected pixel in the background image.

When the image combining unit 180 determines, in step ST1107, that the pixel value of the selected pixel in the target object-simulated radar image is larger than the pixel value of the selected pixel in the background image, in step ST1108, the image combining unit 180 replaces the pixel value of the selected pixel in the background image with the pixel value of the selected pixel in the target object-simulated radar image.

After step ST1108, in step ST1109, the image combining unit 180 determines whether or not all the pixels in the target object-simulated radar image have been selected.

When the image combining unit 180 determines, in step ST1107, that the pixel value of the selected pixel in the target object-simulated radar image is not larger than the pixel value of the selected pixel in the background image, the image combining unit 180 executes processing of step ST1109.

When the image combining unit 180 determines, in step ST1109, that not all the pixels in the target object-simulated radar image have been selected, the image combining unit 180 returns to the processing of step ST1106 and repeatedly executes the processing from step ST1106 to step ST1109 until the image combining unit 180 determines that all the pixels in the target object-simulated radar image have been selected.

When the image combining unit 180 determines, in step ST1109, that all the pixels in the target object-simulated radar image have been selected, the image combining unit 180 ends the processing of the flowchart.

Note that, in the processing of the flowchart, the order of the processing from step ST1101 to step ST1104 is arbitrary.

Furthermore, when generating the combined pseudo radar image, the learning data generation device 100 may generate the combined pseudo radar image by combining the background image and the target object-simulated radar image with transparency of the target object-simulated radar image at a predetermined ratio by alpha blending or the like. Specifically, for example, when the image combining unit 180 replaces the pixel value of the pixel in the background image with the pixel value of the pixel in the target object-simulated radar image in the processing of step ST1108, the image combining unit 180 may multiply the pixel value of the pixel in the target object-simulated radar image by, for example, any value between 0 and 1, and replace the pixel value of the pixel in the background image with the multiplied pixel value.

In the combined pseudo radar image generated in this way, the region to which the target object-simulated radar image is pasted in the combined pseudo radar image becomes unclear, and the learning data generation device 100 can generate learning data having a combined pseudo radar image similar to an actual radar image generated by the radar device 10 performing radar irradiation.

As described above, the learning data generation device 100 includes the 3D model acquiring unit 110 for acquiring the target object 3D-model information indicating the 3D model of the target object, the target object image generating unit 120 for simulating the radar irradiation to the target object using the target object 3D-model information acquired by the 3D model acquiring unit 110 to generate the target object-simulated radar image that is the simulated radar image of the target object, the radar image acquiring unit 130 for acquiring the radar image information indicating the radar image generated by the radar device 10 performing radar irradiation, the background image acquiring unit 140 for acquiring the background image using the radar image information acquired by the radar image acquiring unit 130, the image combining unit 180 for generating a combined pseudo radar image obtained by combining the background image and the target object-simulated radar image by pasting the target object-simulated radar image generated by the target object image generating unit 120 to a predetermined position in the background image acquired by the background image acquiring unit 140; the learning data generating unit 190 for generating learning data that associates the combined simulated radar image information indicating the combined pseudo radar image generated by the image combining unit 180 with class information indicating the type of the target object; and the learning data output unit 199 for outputting the learning data generated by the learning data generating unit 190.

With this configuration, the learning data generation device 100 can easily generate learning data used for machine learning for detecting or identifying a target object appearing in a radar image.

Furthermore, with such a configuration, the learning data generation device 100 generates the background image using the radar image generated by the radar device 10 performing radar irradiation, and thus, it is not necessary to 3D-model the background of the target object.

In addition, since it is not necessary to generate the background image from the 3D model or the like of the background of the target object by numerical calculation, the learning data can be generated in a short time.

Furthermore, in the learning data generation device 100, in the above-described configuration, the learning data generating unit 190 is configured to generate the learning data that associates the position at which the image combining unit 180 has pasted the target object-simulated radar image to the background image with the class information indicating the type of the target object.

With this configuration, the learning data generation device 100 can easily generate learning data with teacher data used for machine learning for detecting or identifying a target object appearing in a radar image.

In addition, the learning data generation device 100 includes, in addition to the above-described configuration, the embedded coordinate acquiring unit 181 for acquiring the information indicating the coordinates of the pixel in the background image in which the image combining unit 180 has replaced the pixel value of the background image with the pixel value of the target object-simulated radar image, and the learning data generating unit 190 is configured to generate the learning data by associating the information indicating the coordinates of the pixel in the background image acquired by the embedded coordinate acquiring unit 181 with the class information indicating the type of the target object.

With this configuration, the learning data generation device 100 can easily generate learning data with teacher data used for machine learning for detecting or identifying a target object appearing in a radar image.

Furthermore, the learning data generation device 100 includes, in addition to the above-described configuration, the position determination unit 160 for determining a position at which the target object-simulated radar image generated by the target object image generating unit 120 is pasted to the background image, on the basis of a 3D model of the target object indicated by the target object 3D-model information and an irradiation direction of the simulated radar irradiation to the target object when the target object image generating unit 120 simulates the radar irradiation to the target object using the target object 3D-model information acquired by the 3D model acquiring unit 110.

With this configuration, the learning data generation device 100 can save the user from inputting the position at which the target object-simulated radar image is pasted to the background image.

In addition, the learning data generation device 100 includes, in addition to the above-described configuration, the size determination unit 170 for determining a size of pasting the target object-simulated radar image generated by the target object image generating unit 120 to the background image on the basis of a ratio between a distance between the 3D model of the target object indicated by the target object 3D-model information and an emission position of the simulated radar irradiation to the target object when the target object image generating unit 120 simulates the radar irradiation to the target object using the target object 3D-model information acquired by the 3D model acquiring unit 110, and a distance between an assumed target object and an emission position of radar irradiation in the radar device 10 when the radar device 10 performs actual radar irradiation.

With this configuration, the learning data generation device 100 can save the user from inputting the size of pasting the target object-simulated radar image to the background image.

Furthermore, in the learning data generation device 100, in the above-described configuration, the radar image acquiring unit 130 acquires the radar image information indicating the radar image in which a wide area is photographed, and the background image acquiring unit 140 cuts out a partial image region of the radar image in which a wide area is photographed indicated by the radar image information acquired by the radar image acquiring unit 130, and acquires the cut out image region as the background image.

With this configuration, the learning data generation device 100 can easily acquire the background image.

Note that, in the above description, with regard to the radar image information output from the radar device 10, it has been described that each pixel value of the radar image indicated by the radar image information indicates the intensity of the reflected radar signal, and the radar image acquiring unit 130 acquires the radar image information in which each pixel value of the radar image indicated by the radar image information generated by the radar device 10 indicates the intensity of the reflected radar signal. However, the radar image indicated by the radar image information acquired by the radar image acquiring unit 130 may be obtained by converting the intensity of the reflected radar signal into a logarithmic scale in each pixel value of the radar image indicated by the radar image information, and further normalizing the intensity of the reflected radar signal after conversion into the logarithmic scale so as to have a value between 0 and 1 or the like, thereby gray-scaling the radar image.

When the radar image indicated by the radar image information acquired by the radar image acquiring unit 130 is gray-scaled, the target object image generating unit 120 generates the target object-simulated radar image as the grayscale image normalized so that each pixel value of the target object-simulated radar image has a value between 0 and 1 or the like. Furthermore, the image combining unit 180 performs the processing of the flowchart illustrated in FIG. 11.

Modification of First Embodiment.

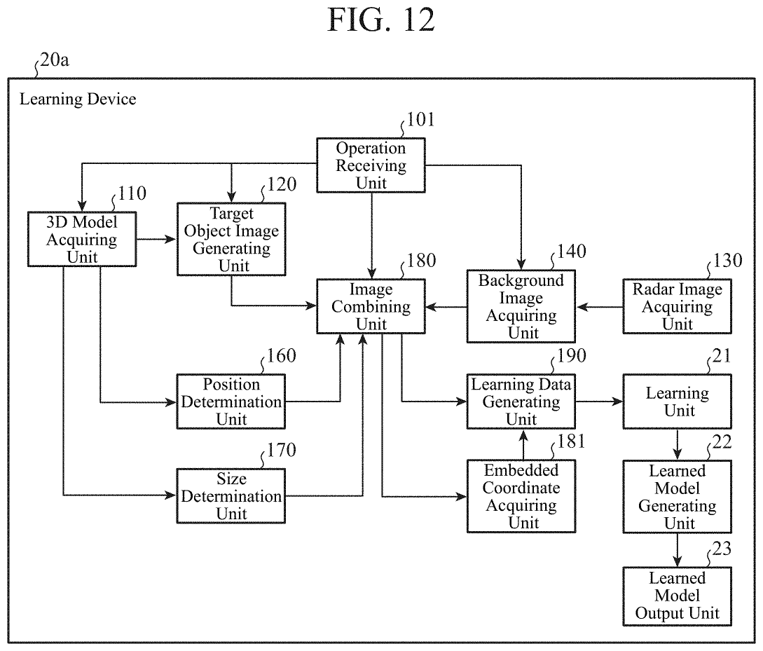

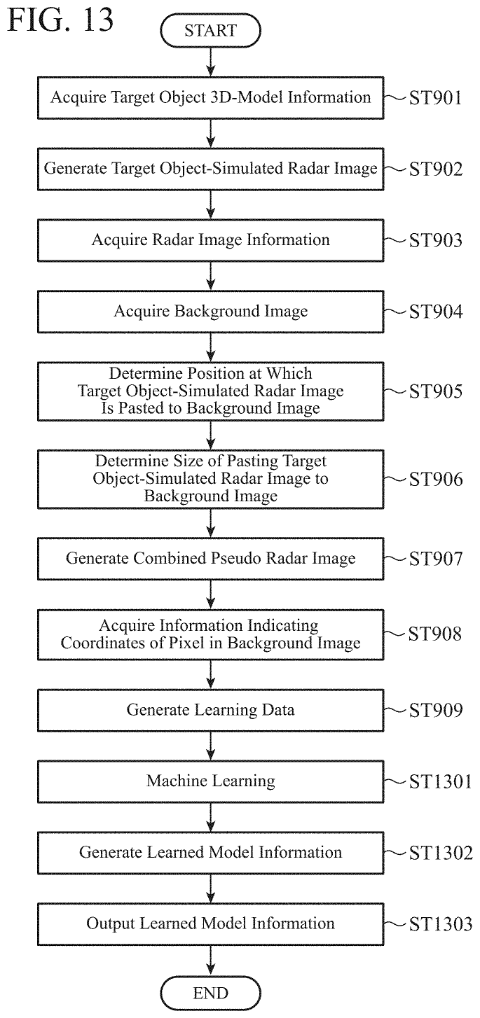

A learning device 20a according to a modification of the first embodiment will be described with reference to FIGS. 12 and 13.

FIG. 12 is a block diagram illustrating an example of a configuration of a main part of the learning device 20a according to the modification of the first embodiment.

The learning device 20a according to the modification of the first embodiment has a function of generating learning data included in the learning data generation device 100 according to the first embodiment, and performs machine learning for detecting or identifying a target object appearing in a radar image using the generated learning data.

As illustrated in FIG. 12, the learning device 20a includes an operation receiving unit 101, a 3D model acquiring unit 110, a target object image generating unit 120, a radar image acquiring unit 130, a background image acquiring unit 140, an image combining unit 180, a learning data generating unit 190, a learning unit 21, a learned model generating unit 22, and a learned model output unit 23.

The learning device 20a may include, in addition to the above-described configuration, a position determination unit 160, a size determination unit 170, and an embedded coordinate acquiring unit 181.

FIG. 12 illustrates a learning device 20a including a position determination unit 160 and a size determination unit 170 in addition to the operation receiving unit 101, the 3D model acquiring unit 110, the target object image generating unit 120, the radar image acquiring unit 130, the background image acquiring unit 140, the image combining unit 180, the learning data generating unit 190, the learning unit 21, the learned model generating unit 22, and the learned model output unit 23.

In the configuration of the learning device 20a according to the modification of the first embodiment, the same reference numerals are given to the same configurations as the learning data generation device 100 according to the first embodiment, and duplicate description will be omitted. That is, the description of the configuration of FIG. 12 having the same reference numerals as those shown in FIG. 2 will be omitted.

The learning unit 21 performs machine learning using the learning data generated by the learning data generating unit 190. Specifically, for example, the learning unit 21 performs supervised learning such as deep learning for detecting or identifying a target object appearing in a radar image using the learning data generated by the learning data generating unit 190. Supervised learning for detecting or identifying a target object by image recognition is known, and thus description thereof is omitted.

The learned model generating unit 22 generates learned model information indicating a learned model corresponding to a learning result by machine learning performed by the learning unit 21. The learned model indicated by the learned model information generated by the learned model generating unit 22 is a neural network or the like having an input layer, an intermediate layer, an output layer, and the like. Note that, in a case where the learned model information has already been generated, the learned model generating unit 22 may update the learned model indicated by the learned model information by machine learning performed by the learning unit 21 to generate the learned model information indicating the learned model corresponding to the learning result.

The learned model output unit 23 outputs the learned model information generated by the learned model generating unit 22. Specifically, for example, the learned model output unit 23 outputs the learned model information generated by the learned model generating unit 22 to the inference device 30 or the storage device 40 illustrated in FIG. 1.

Note that each function of the operation receiving unit 101, the 3D model acquiring unit 110, the target object image generating unit 120, the radar image acquiring unit 130, the background image acquiring unit 140, the position determination unit 160, the size determination unit 170, the image combining unit 180, the embedded coordinate acquiring unit 181, the learning data generating unit 190, the learning unit 21, the learned model generating unit 22, and the learned model output unit 23 in the learning device 20a according to the modification of the first embodiment may be implemented by the processor 201 and the memory 202 in the hardware configuration illustrated as an example in FIGS. 8A and 8B in the first embodiment, or may be implemented by the processing circuit 203.

The operation of the learning device 20a according to the modification of the first embodiment will be described with reference to FIG. 13.

FIG. 13 is a flowchart illustrating an example of processing of the learning device 20a according to the modification of the first embodiment.

For example, the learning device 20a repeatedly executes the processing of the flowchart.

Note that in the operation of the learning device 20a according to the modification of the first embodiment, the operation similar to the operation of the learning data generation device 100 according to the first embodiment illustrated in FIG. 9 is denoted by the same reference numeral, and redundant description is omitted. That is, the description of the processing of FIG. 13 having the same reference numerals as those shown in FIG. 9 will be omitted.

First, the learning device 20a executes processing from step ST901 to step ST909.

After step ST909, in step ST1301, the learning unit 21 performs machine learning.

Next, in step ST1302, the learned model generating unit 22 generates learned model information.

Next, in step ST1303, the learned model output unit 23 outputs the learned model information.

After executing the processing of step ST1303, the learning device 20a ends the processing of the flowchart, returns to the processing of step ST901, and repeatedly executes the processing of the flowchart.

Note that the learning device 20a may repeatedly execute the processing from step ST901 to step ST909 before executing the processing of step ST1301.

As described above, the learning device 20a includes the 3D model acquiring unit 110 for acquiring the target object 3D-model information indicating the 3D model of the target object, the target object image generating unit 120 for simulating the radar irradiation to the target object using the target object 3D-model information acquired by the 3D model acquiring unit 110 to generate the target object-simulated radar image that is the simulated radar image of the target object, the radar image acquiring unit 130 for acquiring the radar image information indicating the radar image generated by the radar device 10 performing the radar irradiation, the background image acquiring unit 140 for acquiring the background image using the radar image information acquired by the radar image acquiring unit 130, the image combining unit 180 for generating a combined pseudo radar image obtained by combining the background image and the target object-simulated radar image by pasting the target object-simulated radar image generated by the target object image generating unit 120 to a predetermined position in the background image acquired by the background image acquiring unit 140, the learning data generating unit 190 for generating learning data that associates combined simulated radar image information indicating the combined pseudo radar image generated by the image combining unit 180 with class information indicating a type of the target object, the learning unit 21 for performing machine learning using the learning data generated by the learning data generating unit 190, the learned model generating unit 22 for generating learned model information indicating a learned model corresponding to a learning result by the machine learning performed by the learning unit 21, and the learned model output unit 23 for outputting the learned model information generated by the learned model generating unit 22.

With such a configuration, the learning device 20a can easily generate the learning data used for machine learning for detecting or identifying the target object appearing in the radar image, and thus, can generate the learned model capable of detecting or identifying the target object appearing in the radar image with high accuracy.

Another Modification of the First Embodiment.

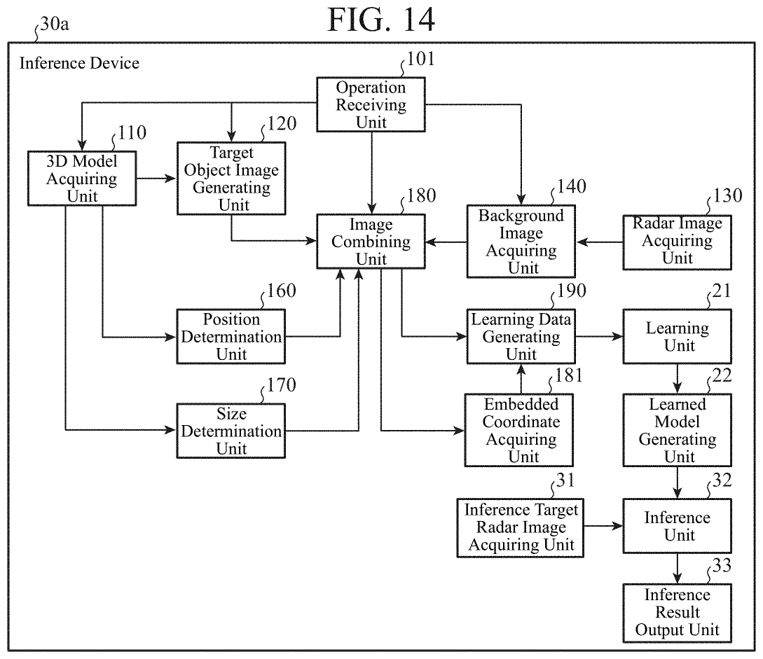

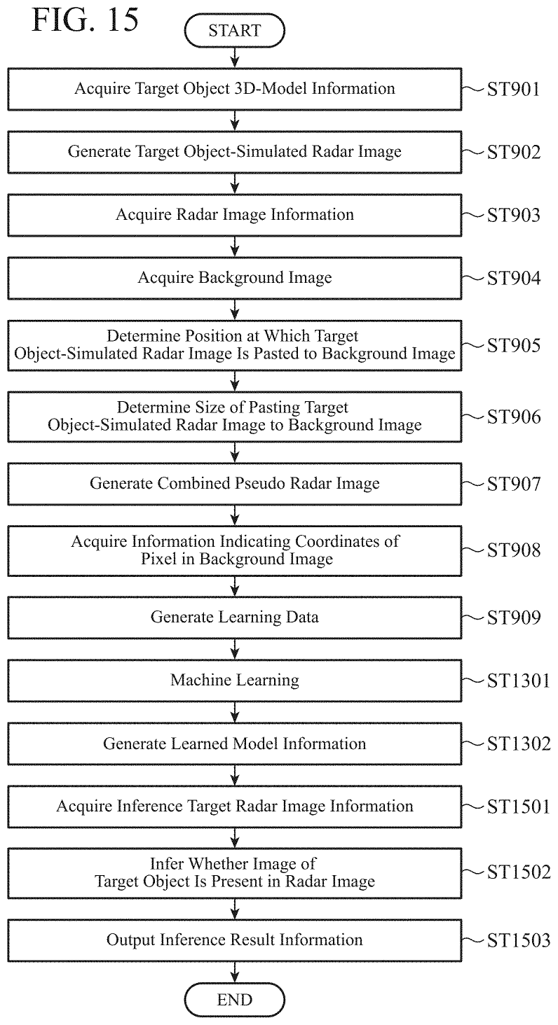

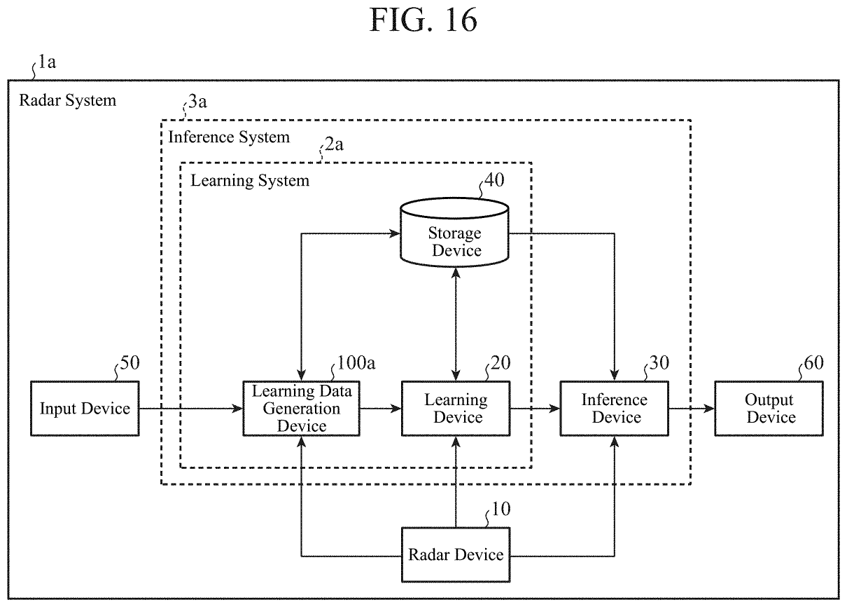

Another modification of the first embodiment different from the modification of the first embodiment will be described with reference to FIGS. 14 and 15.

FIG. 14 is a block diagram illustrating an example of a configuration of a main part of an inference device 30a according to another modification of the first embodiment.

The inference device 30a according to another modification of the first embodiment has a function of generating learning data and learned model information included in the learning device 20a according to the modification of the first embodiment, and detects or identifies a target object appearing in an acquired radar image using the generated learned model information.

As illustrated in FIG. 14, the inference device 30a includes an operation receiving unit 101, a 3D model acquiring unit 110, a target object image generating unit 120, a radar image acquiring unit 130, a background image acquiring unit 140, an image combining unit 180, a learning data generating unit 190, a learning unit 21, a learned model generating unit 22, an inference target radar image acquiring unit 31, an inference unit 32, and an inference result output unit 33.

The inference device 30a may include, in addition to the above-described configuration, a position determination unit 160, a size determination unit 170, and an embedded coordinate acquiring unit 181.

FIG. 14 illustrates the inference device 30a including the position determination unit 160 and the size determination unit 170 in addition to the operation receiving unit 101, the 3D model acquiring unit 110, the target object image generating unit 120, the radar image acquiring unit 130, the background image acquiring unit 140, the image combining unit 180, the learning data generating unit 190, the learning unit 21, the learned model generating unit 22, the inference target radar image acquiring unit 31, the inference unit 32, and the inference result output unit 33.

In the configuration of the inference device 30a according to another modification of the first embodiment, the same components as those of the learning device 20a according to the modification of the first embodiment are denoted by the same reference numerals, and redundant description will be omitted. That is, the description of the configuration of FIG. 14 having the same reference numerals as those shown in FIG. 12 will be omitted.

The inference target radar image acquiring unit 31 acquires inference target radar image information indicating a radar image that is an inference target generated by the radar device 10 performing radar irradiation.

The inference unit 32 uses the learned model indicated by the learned model information generated by the learned model generating unit 22 to infer whether an image of a target object is present in the radar image indicated by the inference target radar image information acquired by the inference target radar image acquiring unit 31.

The inference result output unit 33 outputs inference result information indicating the inference result inferred by the inference unit 32. Specifically, for example, the inference result output unit 33 outputs the inference result information to the output device 60 illustrated in FIG. 1.

Note that each function of the operation receiving unit 101, the 3D model acquiring unit 110, the target object image generating unit 120, the radar image acquiring unit 130, the background image acquiring unit 140, the position determination unit 160, the size determination unit 170, the image combining unit 180, the embedded coordinate acquiring unit 181, the learning data generating unit 190, the learning unit 21, the learned model generating unit 22, the inference target radar image acquiring unit 31, the inference unit 32, and the inference result output unit 33 in the inference device 30a according to another modification of the first embodiment may be implemented by the processor 201 and the memory 202 in the hardware configuration illustrated as an example in FIGS. 8A and 8B in the first embodiment, or may be implemented by the processing circuit 203.

An operation of the inference device 30a according to another modification of the first embodiment will be described with reference to FIG. 15.

FIG. 15 is a flowchart illustrating an example of processing of the inference device 30a according to another modification of the first embodiment.

Note that, in the operation of the inference device 30a according to another modification of the first embodiment, operations similar to the operation of the learning device 20a according to the modification of the first embodiment illustrated in FIG. 13 are denoted by the same reference numerals, and redundant description will be omitted. That is, the description of the processing of FIG. 15 having the same reference numerals as those shown in FIG. 13 will be omitted.

First, the inference device 30a executes processing from step ST901 to step ST909.

After step ST909, the inference device 30a executes processing from step ST1301 to step ST1302.

After step ST1302, in step ST1501, the inference target radar image acquiring unit 31 acquires inference target radar image information.

Next, in step ST1502, the inference unit 32 infers whether an image of a target object is present in the radar image indicated by the inference target radar image information.

Next, in step ST1503, the inference result output unit 33 outputs inference result information.

After executing the processing of step ST1503, the inference device 30a ends the processing of the flowchart.

Note that the inference device 30a may repeatedly execute the processing from step ST901 to step ST909 before executing the processing of step ST1301. Furthermore, the inference device 30a may repeatedly execute the processing from step ST1301 to step ST1302 before executing the processing of step ST1501.

As described above, the inference device 30a includes the 3D model acquiring unit 110 for acquiring the target object 3D-model information indicating the 3D model of the target object, the target object image generating unit 120 for simulating the radar irradiation to the target object using the target object 3D-model information acquired by the 3D model acquiring unit 110 to generate the target object-simulated radar image that is the simulated radar image of the target object, the radar image acquiring unit 130 for acquiring the radar image information indicating the radar image generated by the radar device 10 performing radar irradiation, the background image acquiring unit 140 for acquiring the background image using the radar image information acquired by the radar image acquiring unit 130, the image combining unit 180 for generating a combined pseudo radar image obtained by combining the background image and the target object-simulated radar image by pasting the target object-simulated radar image generated by the target object image generating unit 120 to a predetermined position in the background image acquired by the background image acquiring unit 140, the learning data generating unit 190 for generating learning data that associates combined simulated radar image information indicating the combined pseudo radar image generated by the image combining unit 180 with class information indicating a type of the target object, the learning unit 21 for performing machine learning using the learning data generated by the learning data generating unit 190, the learned model generating unit 22 for generating learned model information indicating a learned model corresponding to a learning result by the machine learning performed by the learning unit 21, the inference target radar image acquiring unit 31 for acquiring inference target radar image information indicating a radar image that is an inference target generated by the radar device 10 performing radar irradiation, the inference unit 32 for inferring whether an image of a target object is present in a radar image indicated by the inference target radar image information acquired by the inference target radar image acquiring unit 31 using the learned model indicated by the learned model information generated by the learned model generating unit 22, and the inference result output unit 33 for outputting inference result information indicating an inference result inferred by the inference unit 32.

With such a configuration, the inference device 30a can easily generate learning data used for machine learning for detecting or identifying a target object appearing in a radar image, and can generate a learned model for detecting or identifying a target object appearing in a radar image with high accuracy using the generated learning data, so that a target object appearing in a radar image can be detected or identified with high accuracy.

### Second Embodiment

A learning data generation device 100a according to the second embodiment will be described with reference to FIGS. 16 to 23.

FIG. 16 is a block diagram illustrating an example of a configuration of a main part of a radar system 1a to which the learning data generation device 100a according to the second embodiment is applied.

The radar system 1a includes a learning data generation device 100a, a radar device 10, a learning device 20, an inference device 30, a storage device 40, an input device 50, and an output device 60.

The radar system 1a is obtained by changing the learning data generation device 100 in the radar system 1 according to the first embodiment to a learning data generation device 100a.

Note that the configuration including the learning data generation device 100a, the learning device 20, and the storage device 40 operates as a learning system 2a.

In addition, the configuration including the learning data generation device 100a, the learning device 20, the inference device 30, and the storage device 40 operates as an inference system 3a.

In the configuration of the radar system 1a according to the second embodiment, the same reference numerals are given to the same configurations as the radar system 1 according to the first embodiment, and duplicate description will be omitted. That is, the description of the configuration of FIG. 16 having the same reference numerals as those shown in FIG. 1 will be omitted.

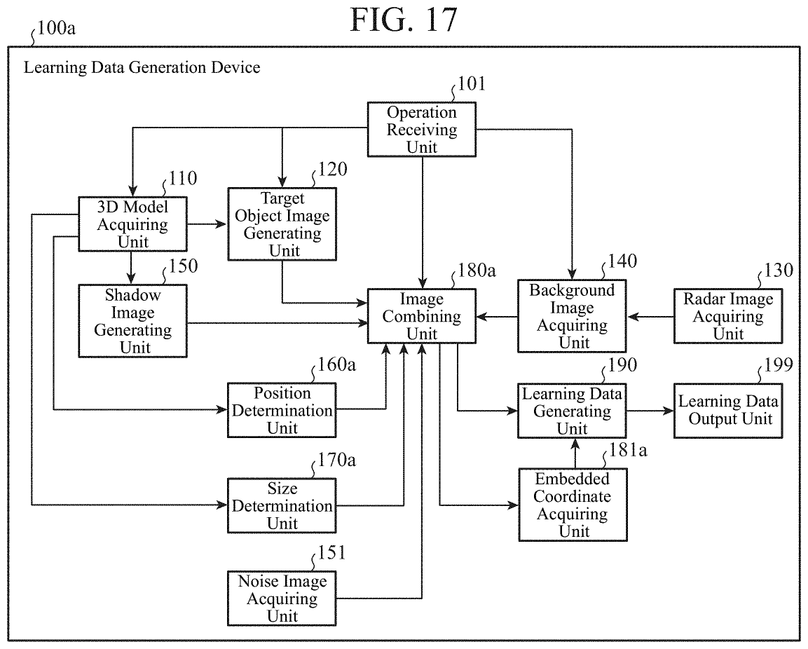

A configuration of a main part of the learning data generation device 100a according to the second embodiment will be described with reference to FIG. 17.

FIG. 17 is a block diagram illustrating an example of a configuration of a main part of the learning data generation device 100a according to the second embodiment.

The learning data generation device 100a includes an operation receiving unit 101, a 3D model acquiring unit 110, a target object image generating unit 120, a radar image acquiring unit 130, a background image acquiring unit 140, a shadow image generating unit 150, an image combining unit 180a, a learning data generating unit 190, and a learning data output unit 199.

The learning data generation device 100a may include, in addition to the above-described configuration, a noise image acquiring unit 151, a position determination unit 160a, a size determination unit 170a, and an embedded coordinate acquiring unit 181a.

As illustrated in FIG. 17, the learning data generation device 100a according to the second embodiment will be described as including the noise image acquiring unit 151, the position determination unit 160a, and the size determination unit 170a.

The learning data generation device 100a illustrated in FIG. 17 is obtained by adding the shadow image generating unit 150 and the noise image acquiring unit 151 to the configuration of the learning data generation device 100 according to the first embodiment illustrated in FIG. 2, and further changing the image combining unit 180, the position determination unit 160, and the size determination unit 170 in the learning data generation device 100 according to the first embodiment to the image combining unit 180a, the position determination unit 160a, and the size determination unit 170a.

In the configuration of the learning data generation device 100a according to the second embodiment, the same reference numerals are given to the same configurations as the learning data generation device 100 according to the first embodiment, and duplicate description will be omitted. That is, the description of the configuration of FIG. 17 having the same reference numerals as those shown in FIG. 2 will be omitted.

The shadow image generating unit 150 simulates radar irradiation to a target object using the target object 3D-model information acquired by the 3D model acquiring unit 110, and calculates a region to be a radar shadow on the basis of a 3D model of the target object indicated by the target object 3D-model information and an irradiation direction of the simulated radar irradiation to the target object to generate a pseudo radar image (hereinafter, referred to as a “shadow pseudo radar image”) indicating the calculated region to be a radar shadow.

More specifically, for example, the shadow image generating unit 150 calculates a region to be a radar shadow in the shadow pseudo radar image on the basis of the following equations (1) and (2),

X₀=X+Z×tan θ Equation (1)

Y₀=Y Equation (2)

in which (X₀, Y₀) is any coordinate to be a radar shadow in the shadow pseudo radar image. Further, (X, Y, Z) is a position on the 3D model surface of the target object indicated by the target object 3D-model information in the XYZ coordinate system with the position where the radar signal is output in the simulated radar irradiation as the origin. Further, θ is an angle formed by the Z axis and a direction from the origin in the XYZ coordinate system toward the position on the 3D model surface of the target object indicated by (X, Y, Z). That is, θ is the irradiation angle of the radar signal in the simulated radar irradiation at the position on the 3D model surface of the target object indicated by (X, Y, Z).

For example, the shadow image generating unit 150 generates the shadow pseudo radar image as a rectangular image in which a value of any coordinate that is the radar shadow in the shadow pseudo radar image indicated by (X₀, Y₀), that is, a pixel value of a pixel that is the radar shadow in the shadow pseudo radar image is set to a predetermined value such as 1, and a value of any coordinate other than (X₀, Y₀), that is, a pixel value of a pixel that is not the radar shadow in the shadow pseudo radar image is set to a value larger than the above-described predetermined value.

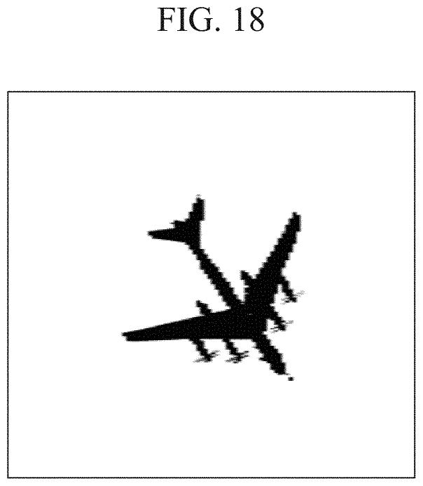

FIG. 18 is a diagram illustrating an example of a shadow pseudo radar image that the shadow image generating unit 150 has generated by simulating radar irradiation to the target object using the target object 3D-model information indicating the 3D model of the target object illustrated in FIG. 3. Note that the shadow pseudo radar image illustrated in FIG. 18 is visualized as a binary monochrome image obtained by normalizing a pixel value of a pixel that is a radar shadow in the shadow pseudo radar image to 0 and a pixel value of a pixel that is not a radar shadow to 1.

The image combining unit 180a generates a combined pseudo radar image obtained by combining the background image, the target object-simulated radar image, and the shadow simulated radar image by pasting the target object-simulated radar image generated by the target object image generating unit 120 and the shadow simulated radar image generated by the shadow image generating unit 150 to a predetermined position in the background image acquired by the background image acquiring unit 140.

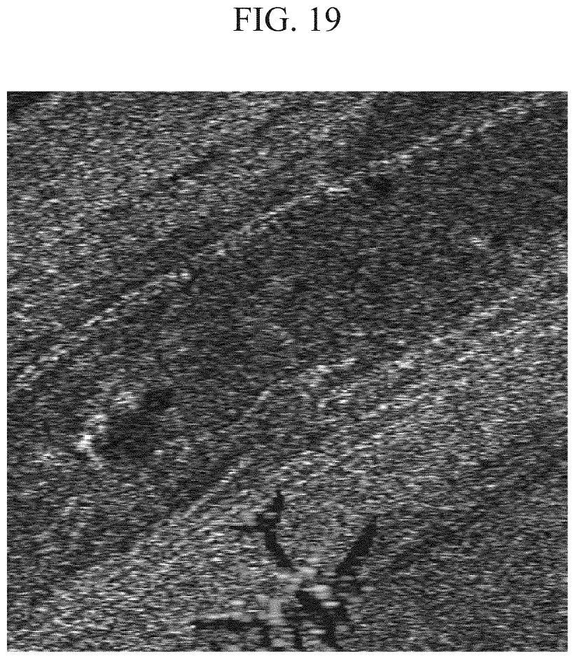

FIG. 19 is a diagram illustrating an example of the combined pseudo radar image generated by the image combining unit 180a. Note that FIG. 19 visualizes the combined pseudo radar image as a grayscale image by normalizing each pixel value of the combined pseudo radar image so as to have a value between 0 and 1.

The noise image acquiring unit 151 acquires a noise image for adding noise to the shadow pseudo radar image generated by the shadow image generating unit 150. The noise image acquiring unit 151 acquires, for example, noise image information indicating a noise image by reading the noise image information from the storage device 40. Furthermore, for example, the noise image acquiring unit 151 may generate and acquire a noise image indicating noise such as Gaussian noise or Rayleigh noise by the noise image acquiring unit 151 performing arithmetic processing on the basis of the radar image indicated by the radar image information acquired by the radar image acquiring unit 130 or the background image acquired by the background image acquiring unit 140 using the radar image information acquired by the radar image acquiring unit 130. Furthermore, for example, the noise image acquiring unit 151 may generate and acquire a noise image indicating noise such as random noise by the noise image acquiring unit 151 performing arithmetic processing.

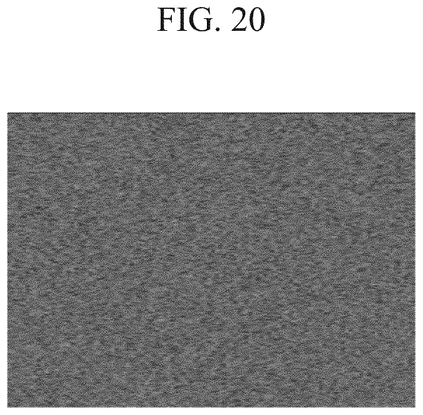

FIG. 20 is a diagram illustrating an example of the noise image acquired by the noise image acquiring unit 151. Note that FIG. 20 is obtained by visualizing the noise image as a grayscale image by normalizing each pixel value of the noise image so as to have a value between 0 and 1.

For example, in a case where the learning data generation device 100a includes the noise image acquiring unit 151, the image combining unit 180a adds noise indicated by the noise image acquired by the noise image acquiring unit 151 to a region at which the image combining unit 180a has pasted the shadow simulated radar image generated by the shadow image generating unit 150 to the background image acquired by the background image acquiring unit 140, and further pastes the target object-simulated radar image, thereby generating a combined pseudo radar image. More specifically, for example, the image combining unit 180a adds the pixel value of the pixel of the noise image corresponding to each pixel of the region at which the shadow simulated radar image has been pasted to the background image to the pixel value of each pixel of the region, and adds the noise indicated by the noise image to the region at which the shadow simulated radar image has been pasted to the background image.

For example, the image combining unit 180a acquires a position in the background image to which the target object-simulated radar image and the shadow simulated radar image are pasted on the basis of the operation information output from the operation receiving unit 101. More specifically, for example, the user inputs a position in the background image to which the target object-simulated radar image and the shadow simulated radar image are pasted by operating the input device 50. The operation receiving unit 101 receives an operation signal indicating a position in the background image to which the target object-simulated radar image and the shadow simulated radar image are pasted, converts the operation signal into operation information corresponding to the operation signal, and outputs the converted operation information to the image combining unit 180a. The image combining unit 180a acquires the operation information from the operation receiving unit 101 to thereby acquire the position in the background image to which the target object-simulated radar image and the shadow simulated radar image are pasted.

Furthermore, for example, in a case where the learning data generation device 100a includes the position determination unit 160a, the position to which the target object-simulated radar image and the shadow simulated radar image are pasted may be determined by the position determination unit 160a.

The position determination unit 160a determines a position at which the target object-simulated radar image generated by the target object image generating unit 120 and the shadow simulated radar image generated by the shadow image generating unit 150 are pasted to the background image on the basis of the 3D model of the target object indicated by the target object 3D-model information and the irradiation direction of the simulated radar irradiation to the target object when the target object image generating unit 120 simulates the radar irradiation to the target object using the target object 3D-model information acquired by the 3D model acquiring unit 110.

In addition, the image combining unit 180a may change the sizes of the target object-simulated radar image generated by the target object image generating unit 120 and the shadow simulated radar image generated by the shadow image generating unit 150 to predetermined sizes, paste the target object-simulated radar image and the shadow simulated radar image after the size change to a predetermined position in the background image acquired by the background image acquiring unit 140, and generate a combined pseudo radar image obtained by combining the background image, the target object-simulated radar image, and the shadow simulated radar image.

For example, in a case where the learning data generation device 100a includes the size determination unit 170a, the changed sizes of the target object-simulated radar image and the shadow simulated radar image are determined by the size determination unit 170a.

The size determination unit 170a determines the size of pasting the target object-simulated radar image generated by the target object image generating unit 120 and the shadow simulated radar image generated by the shadow image generating unit 150 to the background image on the basis of the ratio between the distance between the 3D model of the target object indicated by the target object 3D-model information and the emission position of the simulated radar irradiation to the target object when the target object image generating unit 120 simulates the radar irradiation to the target object using the target object 3D-model information acquired by the 3D model acquiring unit 110 and the distance between the assumed target object and the emission position of the radar irradiation in the radar device 10 when the radar device 10 performs actual radar irradiation.

The learning data generating unit 190 generates learning data that associates combined simulated radar image information indicating the combined pseudo radar image generated by the image combining unit 180a with class information indicating the type of the target object. The learning data generating unit 190 may generate the learning data that associates the position at which the image combining unit 180a has pasted the target object-simulated radar image to the background image with the class information indicating the type of the target object.

The embedded coordinate acquiring unit 181a acquires, from the image combining unit 180a, information indicating coordinates of pixels in the background image in which the image combining unit 180a has replaced the pixel value of the background image with the pixel value of the target object-simulated radar image. The embedded coordinate acquiring unit 181a outputs the acquired information to the learning data generating unit 190. For example, when the learning data generation device 100a includes the embedded coordinate acquiring unit 181a, the learning data generating unit 190 may generate the learning data by associating the coordinates of the pixel in the background image in which the image combining unit 180a has replaced the pixel value of the background image with the pixel value of the target object-simulated radar image with the class information indicating the type of the target object.

Note that each function of the operation receiving unit 101, the 3D model acquiring unit 110, the target object image generating unit 120, the radar image acquiring unit 130, the background image acquiring unit 140, the shadow image generating unit 150, the noise image acquiring unit 151, the position determination unit 160a, the size determination unit 170a, the image combining unit 180a, the embedded coordinate acquiring unit 181a, the learning data generating unit 190, and the learning data output unit 199 in the learning data generation device 100a according to the second embodiment may be implemented by the processor 201 and the memory 202 in the hardware configuration illustrated as an example in FIGS. 8A and 8B in the first embodiment, or may be implemented by the processing circuit 203.

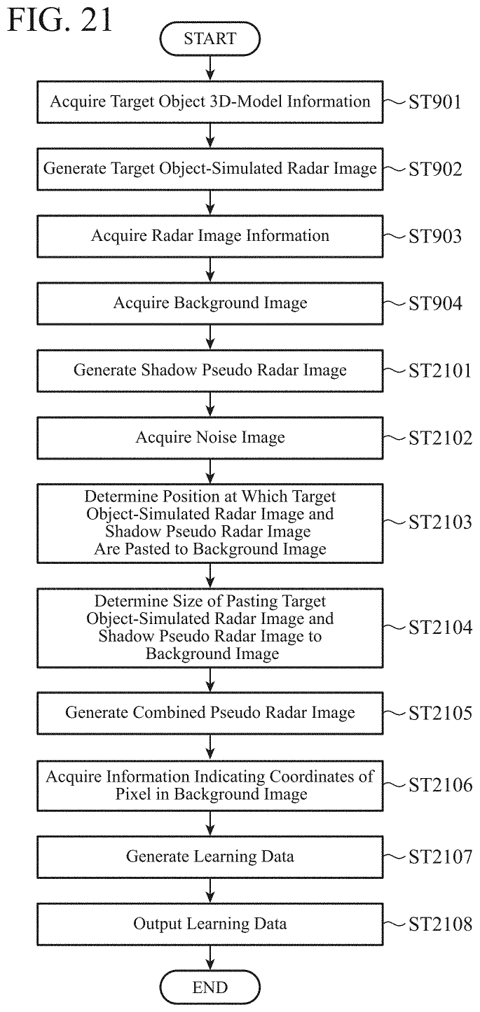

The operation of the learning data generation device 100a according to the second embodiment will be described with reference to FIG. 21.

FIG. 21 is a flowchart illustrating an example of processing of the learning data generation device 100a according to the second embodiment.

For example, the learning data generation device 100a repeatedly executes the processing of the flowchart.

Note that in the operation of the learning data generation device 100a according to the second embodiment, the same reference numerals are given to the same operations as the operations of the learning data generation device 100 according to the first embodiment illustrated in FIG. 9, and redundant description will be omitted. That is, the description of the processing of FIG. 21 having the same reference numerals as those shown in FIG. 9 will be omitted.

First, the learning data generation device 100a executes processing from step ST901 to step ST904.

After step ST904, in step ST2101, the shadow image generating unit 150 generates a shadow pseudo radar image.

Next, in step ST2102, the noise image acquiring unit 151 acquires a noise image.

Next, in step ST2103, the position determination unit 160a determines a position at which the target object-simulated radar image and the shadow pseudo radar image are pasted to the background image.

Next, in step ST2104, the size determination unit 170a determines the size of pasting the target object-simulated radar image and the shadow pseudo radar image to the background image.

Next, in step ST2105, the image combining unit 180a generates a combined pseudo radar image.

Next, in step ST2106, the embedded coordinate acquiring unit 181a acquires information indicating coordinates of a pixel in the background image in which the image combining unit 180a has replaced the pixel value of the background image with the pixel value of the target object-simulated radar image.

Next, in step ST2107, the learning data generating unit 190 generates learning data.

Next, in step ST2108, the learning data output unit 199 outputs the learning data.

After executing the processing of step ST2108, the learning data generation device 100a ends the processing of the flowchart, returns to the processing of step ST901, and repeatedly executes the processing of the flowchart.

Note that, in the processing of the flowchart, if the processing of step ST2102 precedes the processing of step ST2107, the order of the processing of step ST2102 is arbitrary.

Furthermore, in the processing of the flowchart, if the processing of step ST901 precedes the processing of steps ST902 and ST2101, the processing of step ST903 precedes the processing of step ST904, and the processing of steps ST901 to ST904 and the processing of step ST2101 precedes step ST2103, the order of the processing of steps ST901 to ST904 and the processing of step ST2101 is arbitrary.

A method in which the image combining unit 180a generates a combined pseudo radar image by combining a background image, a target object-simulated radar image, and a shadow pseudo radar image will be described.

A first method in which the image combining unit 180a generates a combined pseudo radar image will be described.

For example, the image combining unit 180a pastes the shadow simulated radar image to the background image by replacing a pixel value of a pixel, among the pixels of the background image, in a region to be the radar shadow in the shadow simulated radar image generated by the shadow image generating unit 150, that is, a pixel corresponding to a pixel whose pixel value in the shadow simulated radar image is a predetermined value such as 1, with a pixel value of the shadow simulated radar image.

In a case where the learning data generation device 100a includes the noise image acquiring unit 151, the image combining unit 180a adds, to a pixel value of each pixel in which the pixel value of the background image is replaced with the pixel value of the shadow simulated radar image, for example, in the region at which the shadow simulated radar image is pasted to the background image, the pixel value of the pixel of the noise image corresponding to the pixel, and adds the noise indicated by the noise image to the region at which the shadow simulated radar image is pasted to the background image.

After pasting the shadow simulated radar image to the background image or adding noise to the pasted shadow simulated radar image, for example, the image combining unit 180a adds each pixel value of the target object-simulated radar image to a pixel value of a pixel corresponding to a position of each pixel of the target object-simulated radar image of the background image, thereby pasting the target object-simulated radar image to the background image after the shadow simulated radar image is pasted, and combining the background image, the target object-simulated radar image, and the shadow simulated radar image to generate a combined pseudo radar image.

A second method in which the image combining unit 180a generates a combined pseudo radar image will be described.

In a case where the target object image generating unit 120 generates a target object-simulated radar image as a grayscale image normalized to have a value between 0 and 1 or the like in each pixel value of the target object-simulated radar image, the shadow image generating unit 150 generates a shadow simulated radar image as a binary monochrome image in which, in each pixel value of the shadow simulated radar image, a pixel value of a pixel that is a radar shadow is set to 0 and a pixel value of an image that is not a radar shadow is set to 1, and the background image acquiring unit 140 acquires a background image as a grayscale image normalized to have a value between 0 and 1 or the like in each pixel value of the background image, the image combining unit 180a may generate a combined pseudo radar image as described below, for example.

In this case, for example, the image combining unit 180a calculates each pixel value after pasting the shadow simulated radar image to the background image in the region at which the shadow simulated radar image is pasted to the background image using the following Equation (3), replaces the pixel value of the corresponding background image with the calculated pixel value to generate the background image after the shadow simulated radar image is pasted.

[Pixel value for replacing pixel value of background image]=[Pixel value of background image]×[Pixel value of shadow simulated radar image] Equation (3)

By calculating the pixel value for replacing the pixel value of the background image using Equation (3), the pixel value of the pixel that is the radar shadow can be set to 0, and the pixel value of the pixel that is not the radar shadow can be set to the pixel value of the background image acquired by the background image acquiring unit 140 in each pixel value of the background image after the shadow simulated radar image is pasted.

In a case where the learning data generation device 100a includes the noise image acquiring unit 151, the image combining unit 180a calculates each pixel value to which noise is added after the shadow simulated radar image is pasted to the background image in the region at which the shadow simulated radar image is pasted to the background image by using the following Equation (4), replaces the pixel value of the corresponding background image with the calculated pixel value, and generates the background image to which noise is added after the shadow simulated radar image is pasted.

[Pixel value for replacing pixel value of background image]=[Pixel value of background image]×[Pixel value of shadow simulated radar image]+[Pixel value of noise image]×(1−[Pixel value of shadow simulated radar image]) Equation (4)

By calculating the pixel value for replacing the pixel value of the background image using Equation (4), it is possible to add noise only to a region to be a radar shadow in the region to which the shadow simulated radar image has been pasted in the background image.

Note that, in the above description, it has been described that the shadow image generating unit 150 generates the shadow simulated radar image as the binary monochrome image. However, when the shadow simulated radar image is pasted to the background image, if the shadow simulated radar image is enlarged or reduced, the pixel value at the boundary between the region that is the radar shadow and the region that is not the radar shadow may have a value between 0 and 1. Also in this case, Equation (3) or Equation (4) can be applied.

After pasting the shadow simulated radar image to the background image or adding noise to the pasted shadow simulated radar image, for example, the image combining unit 180a compares each pixel value of the target object-simulated radar image with a pixel value at a position of a pixel corresponding to a position of each pixel of the target object-simulated radar image in the background image after the shadow simulated radar image is pasted to the background image or noise is added to the pasted shadow simulated radar image, and generates a combined pseudo radar image by replacing the pixel value of the background image with the pixel value of the target object-simulated radar image for a pixel in which the pixel value of the target object-simulated radar image is larger than the pixel value of the background image.

The first and second methods in which the image combining unit 180a generates the combined pseudo radar image are merely examples, and the method in which the image combining unit 180a generates the combined pseudo radar image by combining the background image, the target object-simulated radar image, and the shadow pseudo radar image is not limited to the first and second methods described above.

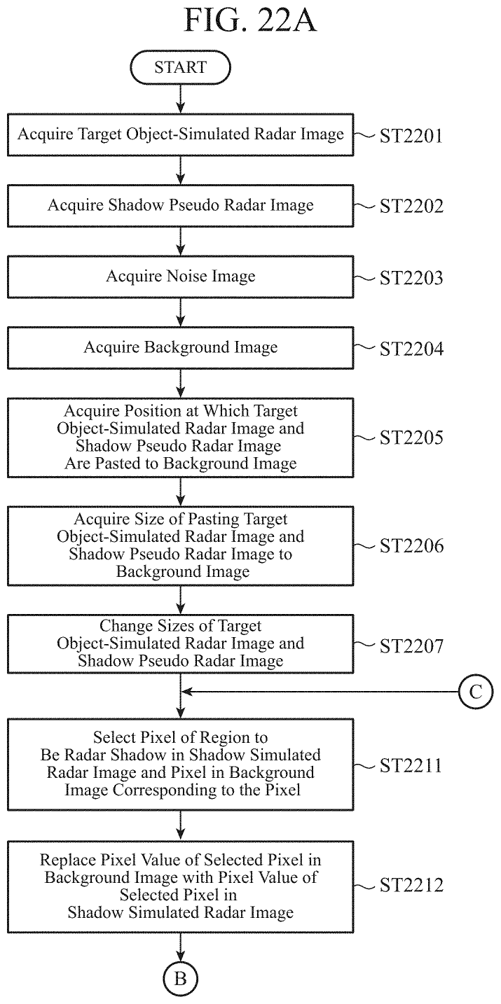

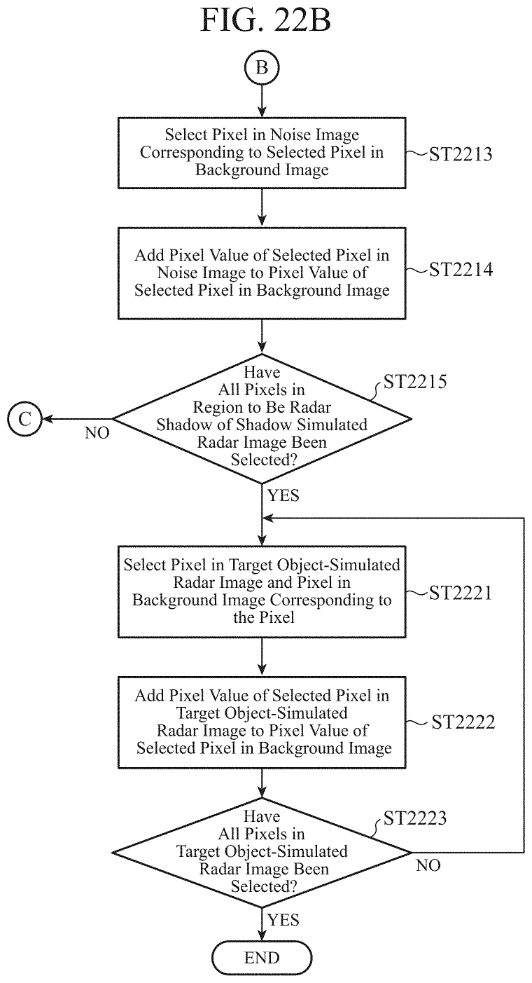

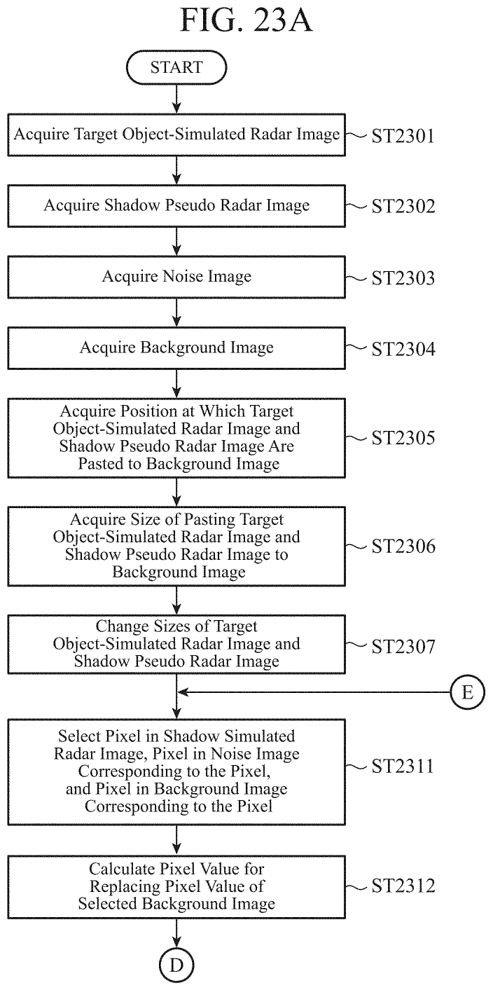

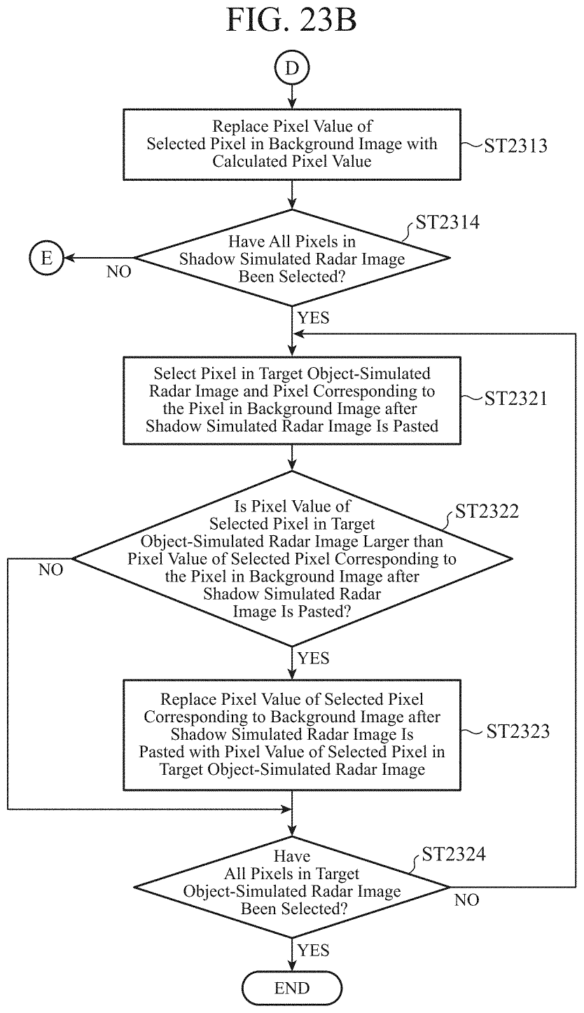

The operation of the image combining unit 180a according to the second embodiment will be described with reference to FIGS. 22 and 23.

FIG. 22 is a flowchart illustrating an example of processing of image combining unit 180a according to the second embodiment. That is, FIG. 22 is a flowchart illustrating processing of step ST2105 illustrated in FIG. 21. The flowchart illustrated in FIG. 22 illustrates the operation of the image combining unit 180a in the first method in which the image combining unit 180a generates a combined pseudo radar image. Note that FIG. 22A illustrates a part of the processing flow of the image combining unit 180a according to the second embodiment, and FIG. 22B illustrates the rest of the processing flow of the image combining unit 180a according to the second embodiment.

First, in step ST2201, the image combining unit 180a acquires a target object-simulated radar image.

Next, in step ST2202, the image combining unit 180a acquires a shadow pseudo radar image.

Next, in step ST2203, the image combining unit 180a acquires a noise image.

Next, in step ST2204, the image combining unit 180a acquires a background image.

Next, in step ST2205, the image combining unit 180a acquires a position at which the target object-simulated radar image and the shadow pseudo radar image are pasted to the background image.

Next, in step ST2206, the image combining unit 180a acquires the size of pasting the target object-simulated radar image and the shadow pseudo radar image to the background image.

Next, in step ST2207, the image combining unit 180a changes the sizes of the target object-simulated radar image and the shadow pseudo radar image on the basis of the sizes of pasting the target object-simulated radar image and the shadow pseudo radar image to the background image.

Next, in step ST2211, the image combining unit 180a selects a pixel in a region to be a radar shadow in the shadow simulated radar image and a pixel in the background image corresponding to the pixel.

Next, in step ST2212, the image combining unit 180a replaces the pixel value of the selected pixel in the background image with the pixel value of the selected pixel in the shadow simulated radar image.

Next, in step ST2213, the image combining unit 180a selects a pixel in the noise image corresponding to the selected pixel in the background image.

Next, in step ST2214, the image combining unit 180a adds the pixel value of the selected pixel in the noise image to the pixel value of the selected pixel in the background image.

Next, in step ST2215, the image combining unit 180a determines whether or not all the pixels in the region to be the radar shadow of the shadow simulated radar image have been selected.

In step ST2215, in a case where the image combining unit 180a determines that not all the pixels in the region to be the radar shadow of the shadow simulated radar image have been selected, the image combining unit 180a returns to the processing of step ST2211, and repeatedly executes the processing of steps ST2211 to ST2215 until the image combining unit 180a determines that all the pixels in the region to be the radar shadow of the shadow simulated radar image have been selected.

In step ST2215, in a case where the image combining unit 180a determines that all the pixels in the region to be the radar shadow of the shadow simulated radar image have been selected, the image combining unit 180a, in step ST2221, selects a pixel in the target object-simulated radar image and a pixel in the background image corresponding to the pixel.

Next, in step ST2222, the image combining unit 180a adds the pixel value of the selected pixel in the target object-simulated radar image to the pixel value of the selected pixel in the background image.

Next, in step ST2223, the image combining unit 180a determines whether or not all the pixels in the target object-simulated radar image have been selected.

In step ST2223, when the image combining unit 180a determines that not all the pixels in the target object-simulated radar image have been selected, the image combining unit 180a returns to the processing of step ST2221 and repeatedly executes the processing from step ST2221 to step ST2223 until the image combining unit 180a determines that all the pixels in the target object-simulated radar image have been selected.

In step ST2223, when the image combining unit 180a determines that all the pixels in the target object-simulated radar image have been selected, the image combining unit 180a ends the processing of the flowchart.

Note that, in the processing of the flowchart, the order of the processing from step ST2201 to step ST2206 is arbitrary.

Furthermore, in the processing of the flowchart, the processing of steps ST2213 and ST2214 is omitted in a case where the learning data generation device 100a does not include the noise image acquiring unit 151.

In addition, when generating the combined pseudo radar image, the learning data generation device 100a may generate the combined pseudo radar image by combining the background image, the target object-simulated radar image, and the shadow simulated radar image with transparency of the region to be the radar shadow in the shadow simulated radar image at a predetermined ratio by alpha blending or the like. Specifically, for example, after the image combining unit 180a replaces the pixel value of the pixel in the background image with the pixel value of the pixel in the shadow simulated radar image in the processing of step ST2212, the image combining unit 180a may multiply the pixel value of the pixel in the background image by, for example, any value between 0 and 1, and add the multiplied pixel value to the replaced pixel value of the pixel in the background image.

In the background image to which the region to be the radar shadow has been pasted in the shadow simulated radar image generated in this way, the region to be the radar shadow in the shadow simulated radar image becomes unclear, and the learning data generation device 100a can generate the learning data having the combined pseudo radar image similar to the region to be the radar shadow in the actual radar image generated by the radar device 10 performing the radar irradiation.

Furthermore, when generating the combined pseudo radar image, the learning data generation device 100a may generate the combined pseudo radar image by combining the background image, the target object-simulated radar image, and the shadow simulated radar image with transparency of the target object-simulated radar image at a predetermined ratio by alpha blending or the like. Specifically, for example, when the image combining unit 180a adds the pixel value of the pixel in the target object-simulated radar image to the pixel value of the pixel in the background image in the processing of step ST2222, the image combining unit 180a may multiply the pixel value of the pixel in the target object-simulated radar image by, for example, any value between 0 and 1, and add the multiplied pixel value to the pixel value of the pixel in the background image.

In the combined pseudo radar image generated in this way, the region to which the target object-simulated radar image has been pasted in the combined pseudo radar image becomes unclear, and the learning data generation device 100a can generate learning data having a combined pseudo radar image similar to the actual radar image generated by the radar device 10 performing the radar irradiation.

FIG. 23 is a flowchart illustrating an example of processing of the image combining unit 180a according to the second embodiment. That is, FIG. 23 is a flowchart illustrating processing of step ST2105 illustrated in FIG. 21. The flowchart illustrated in FIG. 23 illustrates the operation of the image combining unit 180a in the second method in which the image combining unit 180a generates a combined pseudo radar image. Note that FIG. 23A illustrates a part of the processing flow of the image combining unit 180a according to the second embodiment, and FIG. 23B illustrates the rest of the processing flow of the image combining unit 180a according to the second embodiment.

First, in step ST2301, the image combining unit 180a acquires a target object-simulated radar image.

Next, in step ST2302, the image combining unit 180a acquires a shadow pseudo radar image.

Next, in step ST2303, the image combining unit 180a acquires a noise image.

Next, in step ST2304, the image combining unit 180a acquires a background image.

Next, in step ST2305, the image combining unit 180a acquires a position at which the target object-simulated radar image and the shadow pseudo radar image are pasted to the background image.

Next, in step ST2306, the image combining unit 180a acquires the size of pasting the target object-simulated radar image and the shadow pseudo radar image to the background image.

Next, in step ST2307, the image combining unit 180a changes the sizes of the target object-simulated radar image and the shadow pseudo radar image on the basis of the size of pasting the target object-simulated radar image and the shadow pseudo radar image to the background image.

Next, in step ST2311, the image combining unit 180a selects a pixel in the shadow simulated radar image, a pixel in the noise image corresponding to that pixel, and a pixel in the background image corresponding to that pixel.

Next, in step ST2312, the image combining unit 180a calculates a pixel value for replacing the selected pixel value of the background image by using Equation (4).

Next, in step ST2313, the image combining unit 180a replaces the pixel value of the selected pixel in the background image with the calculated pixel value.

Next, in step ST2314, the image combining unit 180a determines whether or not all the pixels in the shadow simulated radar image have been selected.

In step ST2314, in a case where the image combining unit 180a determines that not all the pixels in the shadow simulated radar image have been selected, the image combining unit 180a returns to the processing of step ST2311 and repeatedly executes the processing from step ST2311 to step ST2314 until the image combining unit 180a determines that all the pixels in the shadow simulated radar image have been selected.

In step ST2314, in a case where the image combining unit 180a determines that all the pixels in the shadow simulated radar image have been selected, the image combining unit 180a executes the processing of step ST2321.

In step ST2321, the image combining unit 180a selects a pixel in the target object-simulated radar image and a pixel corresponding to the pixel in the background image after the shadow simulated radar image is pasted or the background image after noise is added to the background image after pasting.

Next, in step ST2322, the image combining unit 180a determines whether or not the pixel value of the selected pixel in the target object-simulated radar image is larger than the pixel value of the selected pixel corresponding to the pixel in the background image after the shadow simulated radar image is pasted or the background image after noise is added to the background image after pasting.

In step ST2322, in a case where the image combining unit 180a determines that the pixel value of the selected pixel in the target object-simulated radar image is larger than the pixel value of the selected pixel in the background image after the shadow simulated radar image is pasted or the background image after noise is added to the background image after pasting, in step ST2323, the image combining unit 180a replaces the pixel value of the selected pixel corresponding to the pixel in the background image after the shadow simulated radar image is pasted or the background image after the noise is added to the background image after pasting with the pixel value of the selected pixel in the target object-simulated radar image.

After step ST2323, in step ST2324, the image combining unit 180a determines whether or not all the pixels in the target object-simulated radar image have been selected.

In step ST2322, in a case where the image combining unit 180a determines that the pixel value of the selected pixel in the target object-simulated radar image is not larger than the pixel value of the selected pixel corresponding to the pixel in the background image after the shadow simulated radar image is pasted or the background image after noise is added to the background image after pasting, the image combining unit 180a executes processing of step ST2324.

In step ST2324, when the image combining unit 180a determines that not all the pixels in the target object-simulated radar image have been selected, the image combining unit 180a returns to the processing of step ST2321 and repeatedly executes the processing from step ST2321 to step ST2324 until the image combining unit 180a determines that all the pixels in the target object-simulated radar image have been selected.

In step ST2324, when the image combining unit 180a determines that all the pixels in the target object-simulated radar image have been selected, the image combining unit 180a ends the processing of the flowchart.

Note that, in the processing of the flowchart, the order of the processing from step ST2301 to step ST2306 is arbitrary.

Furthermore, in the processing of the flowchart, in a case where the learning data generation device 100a does not include the noise image acquiring unit 151, the processing of step ST2312 calculates the pixel value for replacing the selected pixel value of the background image using Equation (3).

In addition, when generating the combined pseudo radar image, the learning data generation device 100a may generate the combined pseudo radar image by combining the background image, the target object-simulated radar image, and the shadow simulated radar image with transparency of the region to be the radar shadow in the shadow simulated radar image at a predetermined ratio by alpha blending or the like. Specifically, for example, after the processing of step ST2312, the image combining unit 180a may multiply the pixel value of the pixel in the background image before being replaced with the pixel value calculated using Equation (4) by, for example, any value between 0 and 1, and add the multiplied pixel value to the pixel value of the pixel in the background image after being replaced with the pixel value calculated using Equation (4), in the pixel of the region of the background image to which the region to be the radar shadow in the shadow simulated radar image has been pasted.

In the background image to which the region to be the radar shadow has been pasted in the shadow simulated radar image generated in this way, the region to be the radar shadow in the shadow simulated radar image becomes unclear, and the learning data generation device 100a can generate the learning data having the combined pseudo radar image similar to the region to be the radar shadow in the actual radar image generated by the radar device 10 performing the radar irradiation.

Furthermore, when generating the combined pseudo radar image, the learning data generation device 100a may generate the combined pseudo radar image by combining the background image, the target object-simulated radar image, and the shadow simulated radar image with transparency of the target object-simulated radar image at a predetermined ratio by alpha blending or the like. Specifically, for example, when the image combining unit 180a replaces the pixel value of the pixel in the background image with the pixel value of the pixel in the target object-simulated radar image in the processing of step ST2323, the image combining unit 180a may multiply the pixel value of the pixel in the target object-simulated radar image by, for example, any value between 0 and 1, and replace the pixel value of the pixel in the background image with the multiplied pixel value.

In the combined pseudo radar image generated in this way, the region to which the target object-simulated radar image has been pasted in the combined pseudo radar image becomes unclear, and the learning data generation device 100a can generate learning data having a combined pseudo radar image similar to the actual radar image generated by the radar device 10 performing the radar irradiation.

As described above, the learning data generation device 100a includes the 3D model acquiring unit 110 for acquiring the target object 3D-model information indicating the 3D model of the target object, the target object image generating unit 120 for simulating the radar irradiation to the target object using the target object 3D-model information acquired by the 3D model acquiring unit 110 to generate the target object-simulated radar image that is the simulated radar image of the target object, the radar image acquiring unit 130 for acquiring the radar image information indicating the radar image generated by the radar device 10 performing radar irradiation, the background image acquiring unit 140 for acquiring the background image using the radar image information acquired by the radar image acquiring unit 130, the image combining unit 180a for generating a combined pseudo radar image obtained by combining the background image and the target object-simulated radar image by pasting the target object-simulated radar image generated by the target object image generating unit 120 to a predetermined position in the background image acquired by the background image acquiring unit 140; the learning data generating unit 190 for generating learning data that associates the combined simulated radar image information indicating the combined pseudo radar image generated by the image combining unit 180a with class information indicating the type of the target object; the learning data output unit 199 for outputting the learning data generated by the learning data generating unit 190: and the shadow image generating unit 150 for simulating radar irradiation to the target object using the target object 3D-model information acquired by the 3D model acquiring unit 110, calculating a region to be a radar shadow on the basis of a 3D model of the target object indicated by the target object 3D-model information and an irradiation direction of the simulated radar irradiation to the target object, and generating a shadow pseudo radar image indicating the calculated region to be the radar shadow, and the image combining unit 180a is configured to paste the target object-simulated radar image generated by the target object image generating unit 120 and the shadow simulated radar image generated by the shadow image generating unit 150 to a predetermined position in the background image acquired by the background image acquiring unit 140 to generate a combined pseudo radar image obtained by combining the background image, the target object-simulated radar image, and the shadow simulated radar image.

With this configuration, the learning data generation device 100a can easily generate learning data used for machine learning for detecting or identifying a target object appearing in a radar image.

Furthermore, with such a configuration, the learning data generation device 100a can generate learning data having a combined pseudo radar image similar to an actual radar image generated by the radar device 10 performing radar irradiation.

Furthermore, with such a configuration, the learning data generation device 100a generates the background image by using the radar image generated by the radar device 10 performing radar irradiation, and thus, it is not necessary to 3D-model the background of the target object.

In addition, since it is not necessary to generate the background image from the 3D model or the like of the background of the target object by numerical calculation, the learning data can be generated in a short time.

In addition, in the learning data generation device 100a, in the above-described configuration, the learning data generating unit 190 is configured to generate the learning data that associates the position at which the image combining unit 180a has pasted the target object-simulated radar image to the background image with the class information indicating the type of the target object.

With this configuration, the learning data generation device 100a can easily generate learning data with teacher data used for machine learning for detecting or identifying a target object appearing in a radar image.

In addition, in the learning data generation device 100a, the image combining unit 180a includes, in addition to the above-described configuration, the embedded coordinate acquiring unit 181a for acquiring information indicating the coordinates of the pixel in the background image in which the pixel value of the background image is replaced with the pixel value of the target object-simulated radar image, and the learning data generating unit 190 is configured to generate the learning data by associating the information indicating the coordinates of the pixel in the background image acquired by the embedded coordinate acquiring unit 181a with the class information indicating the type of the target object.

With this configuration, the learning data generation device 100a can easily generate learning data with teacher data used for machine learning for detecting or identifying a target object appearing in a radar image.

Furthermore, the learning data generation device 100a includes, in addition to the above-described configuration, the noise image acquiring unit 151 for acquiring a noise image for adding noise to the shadow pseudo radar image generated by the shadow image generating unit 150, and the image combining unit 180a is configured to generate a combined pseudo radar image by adding noise indicated by the noise image acquired by the noise image acquiring unit 151 to a region at which the shadow simulated radar image generated by the shadow image generating unit 150 is pasted to the background image acquired by the background image acquiring unit 140, and further pasting the target object-simulated radar image.

With this configuration, the learning data generation device 100a can easily generate learning data used for machine learning for detecting or identifying a target object appearing in a radar image.

Furthermore, with such a configuration, the learning data generation device 100a can generate learning data having a combined pseudo radar image similar to an actual radar image generated by the radar device 10 performing radar irradiation.

In addition, the learning data generation device 100a includes, in addition to the above-described configuration, the position determination unit 160a for determining a position at which the target object-simulated radar image generated by the target object image generating unit 120 and the shadow simulated radar image generated by the shadow image generating unit 150 are pasted to the background image on the basis of the 3D model of the target object indicated by the target object 3D-model information and the irradiation direction of the simulated radar irradiation to the target object when the target object image generating unit 120 simulates the radar irradiation to the target object using the target object 3D-model information acquired by the 3D model acquiring unit 110.

With this configuration, the learning data generation device 100a can save the user from inputting the position at which the target object-simulated radar image and the shadow pseudo radar image are pasted to the background image.

In addition, the learning data generation device 100a includes, in addition to the above-described configuration, the size determination unit 170a for determining a size of pasting the target object-simulated radar image generated by the target object image generating unit 120 and the shadow simulated radar image generated by the shadow image generating unit 150 to the background image on the basis of a ratio between a distance between a 3D model of the target object indicated by the target object 3D-model information and an emission position of the simulated radar irradiation to the target object when the target object image generating unit 120 simulates the radar irradiation to the target object using the target object 3D-model information acquired by the 3D model acquiring unit 110, and a distance between an assumed target object and an emission position of radar irradiation in the radar device 10 when the radar device 10 performs actual radar irradiation.

With this configuration, the learning data generation device 100a can save the user from inputting the size of pasting the target object-simulated radar image to the background image.

In addition, in the learning data generation device 100a, in the above-described configuration, the radar image acquiring unit 130 acquires radar image information indicating a radar image in which a wide area is photographed, and the background image acquiring unit 140 cuts out a partial image region of a radar image in which a wide area is photographed indicated by the radar image information acquired by the radar image acquiring unit 130, and acquires the cut out image region as a background image.

With this configuration, the learning data generation device 100a can easily acquire the background image.

Note that, in the above description, with regard to the radar image information output from the radar device 10, it has been described that each pixel value of the radar image indicated by the radar image information indicates the intensity of the reflected radar signal, and the radar image acquiring unit 130 acquires the radar image information in which each pixel value of the radar image indicated by the radar image information generated by the radar device 10 indicates the intensity of the reflected radar signal. However, the radar image indicated by the radar image information acquired by the radar image acquiring unit 130 may be obtained by converting the intensity of the reflected radar signal into a logarithmic scale in each pixel value of the radar image indicated by the radar image information, and further normalizing the intensity of the reflected radar signal after conversion into the logarithmic scale so as to have a value between 0 and 1 or the like, thereby gray-scaling the radar image.

In a case where the radar image indicated by the radar image information acquired by the radar image acquiring unit 130 is gray-scaled, for example, the target object image generating unit 120 generates the target object-simulated radar image as a grayscale image normalized so that each pixel value of the target object-simulated radar image is a value between 0 and 1. In addition, the shadow image generating unit 150 generates the shadow simulated radar image as a binary monochrome image or the like in which, in each pixel value of the shadow simulated radar image, the pixel value of the pixel that is the radar shadow is set to 0 and the pixel value of the image that is not the radar shadow is set to 1. Furthermore, the noise image acquiring unit 151 acquires the noise image as a grayscale image normalized so that each pixel value of the noise image has a value between 0 and 1, or the like. Furthermore, the image combining unit 180a performs processing illustrated in the flowchart of FIG. 23.

### Third Embodiment

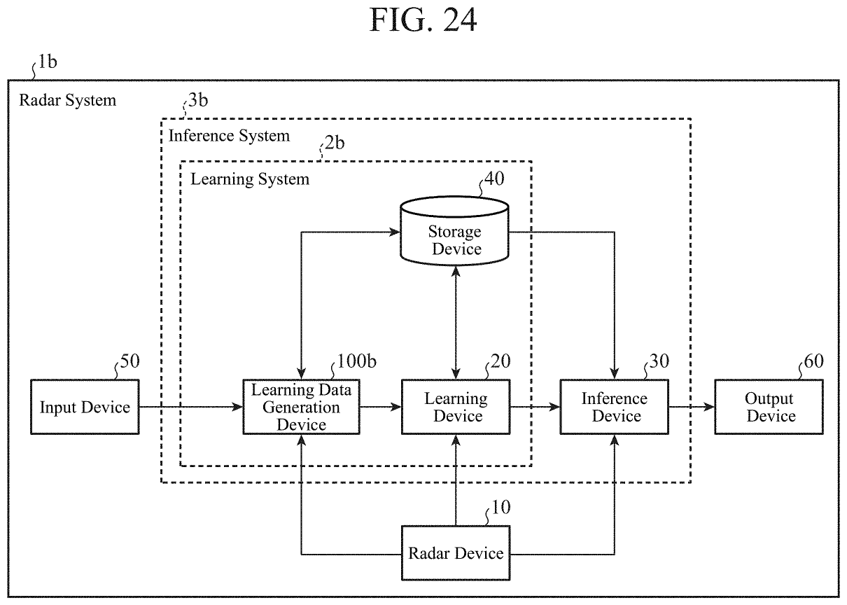

A learning data generation device 100b according to the third embodiment will be described with reference to FIGS. 24 to 26.

The learning data generation device 100a according to the second embodiment pastes the generated target object-simulated radar image and the generated shadow pseudo radar image to the acquired background image to generate a combined pseudo radar image obtained by combining the background image, the target object-simulated radar image, and the shadow simulated radar image.

On the other hand, the learning data generation device 100b according to the third embodiment generates a target object-simulated radar image including the generated shadow pseudo radar image, and generates a combined pseudo radar image obtained by combining the background image and the target object-simulated radar image including the shadow simulated radar image by pasting the generated target object-simulated radar image to the acquired background image.

FIG. 24 is a block diagram illustrating an example of a configuration of a main part of a radar system 1b to which the learning data generation device 100b according to the third embodiment is applied.

The radar system 1b includes a learning data generation device 100b, a radar device 10, a learning device 20, an inference device 30, a storage device 40, an input device 50, and an output device 60.

The radar system 1b is obtained by replacing the learning data generation device 100 in the radar system 1 according to the first embodiment with the learning data generation device 100b.

Note that the configuration including the learning data generation device 100b, the learning device 20, and the storage device 40 operates as a learning system 2b.

In addition, the configuration including the learning data generation device 100b, the learning device 20, the inference device 30, and the storage device 40 operates as an inference system 3b.

In the configuration of the radar system 1b according to the third embodiment, the same reference numerals are given to the same configurations as the radar system 1 according to the first embodiment, and duplicate description will be omitted. That is, the description of the configuration of FIG. 24 having the same reference numerals as those shown in FIG. 1 will be omitted.

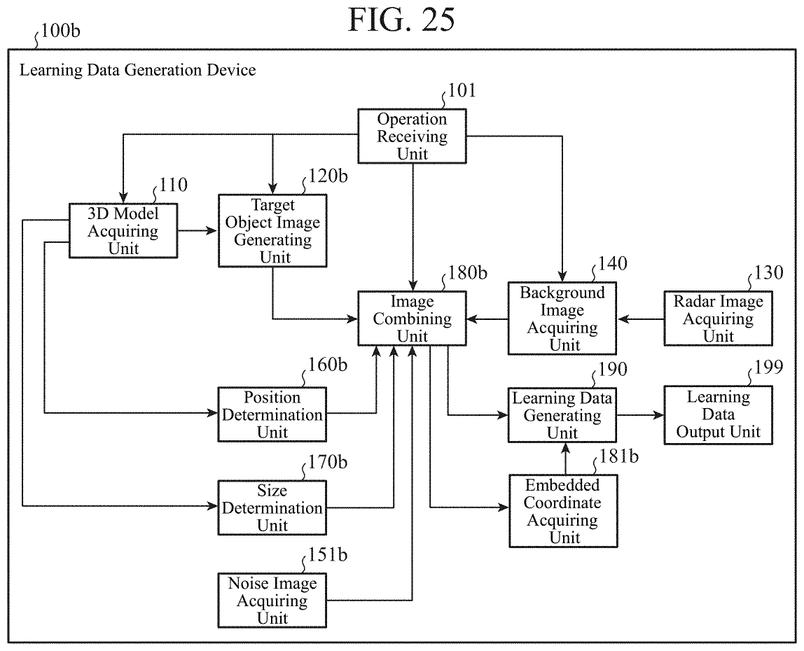

A configuration of a main part of the learning data generation device 100b according to the third embodiment will be described with reference to FIG. 25.

FIG. 25 is a block diagram illustrating an example of a configuration of a main part of the learning data generation device 100b according to the third embodiment.

The learning data generation device 100b includes an operation receiving unit 101, a 3D model acquiring unit 110, a target object image generating unit 120b, a radar image acquiring unit 130, a background image acquiring unit 140, an image combining unit 180b, a learning data generating unit 190, and a learning data output unit 199.

The learning data generation device 100b may include, in addition to the above-described configuration, a noise image acquiring unit 151b, a position determination unit 160b, a size determination unit 170b, and an embedded coordinate acquiring unit 181b.

As illustrated in FIG. 25, the learning data generation device 100b according to the third embodiment will be described as including the noise image acquiring unit 151b, the position determination unit 160b, and the size determination unit 170b.

In the learning data generation device 100b illustrated in FIG. 25, the noise image acquiring unit 151b is added to the configuration of the learning data generation device 100 according to the first embodiment illustrated in FIG. 2, and further the image combining unit 180, the position determination unit 160, and the size determination unit 170 in the learning data generation device 100 according to the first embodiment are replaced with the image combining unit 180b, the position determination unit 160b, and the size determination unit 170b.

In the configuration of the learning data generation device 100b according to the third embodiment, the same reference numerals are given to the same configurations as the learning data generation device 100 according to the first embodiment, and duplicate description will be omitted. That is, the description of the configuration of FIG. 25 having the same reference numerals as those shown in FIG. 2 will be omitted.

The target object image generating unit 120b simulates radar irradiation to the target object using the target object 3D-model information acquired by the 3D model acquiring unit 110 to generate a target object-simulated radar image that is a simulated radar image of the target object. When generating the target object-simulated radar image, the target object image generating unit 120b calculates a region to be a radar shadow on the basis of the 3D model of the target object indicated by the target object 3D-model information and the irradiation direction of the simulated radar irradiation to the target object, generates a shadow pseudo radar image indicating the calculated region to be the radar shadow, and generates the target object-simulated radar image by including the generated shadow pseudo radar image in the target object-simulated radar image.

Specifically, for example, the target object image generating unit 120b generates the shadow pseudo radar image by a method similar to the method in which the shadow image generating unit 150 in the learning data generation device 100a according to the second embodiment generates the shadow pseudo radar image. Therefore, description of a method in which the target object image generating unit 120b generates the shadow pseudo radar image is omitted.

In addition, for example, the target object image generating unit 120b combines the generated shadow pseudo radar image and the target object-simulated radar image generated by simulating the radar irradiation to the target object using the target object 3D-model information acquired by the 3D model acquiring unit 110 by pasting the generated shadow pseudo radar image to the target object-simulated radar image to generate the target object-simulated radar image after the shadow pseudo radar image is pasted.

The image combining unit 180b pastes the target object-simulated radar image including the shadow pseudo radar image generated by the target object image generating unit 120b to a predetermined position in the background image acquired by the background image acquiring unit 140 to generate a combined pseudo radar image obtained by combining the background image and the target object-simulated radar image including the shadow simulated radar image. Specifically, for example, the image combining unit 180b replaces the pixel value at the position of the pixel corresponding to the position of each pixel of the target object-simulated radar image including the shadow simulated radar image of the background image by using each pixel value of the target object-simulated radar image including the shadow simulated radar image, thereby combining the background image and the target object-simulated radar image including the shadow simulated radar image to generate a combined pseudo radar image.

The noise image acquiring unit 151b acquires a noise image for adding noise to a region to be a radar shadow in the target object-simulated radar image including the shadow pseudo radar image generated by the target object image generating unit 120b. The noise image acquiring unit 151b has a function similar to that of the noise image acquiring unit 151 in the learning data generation device 100a according to the second embodiment. Description of a method in which the noise image acquiring unit 151b acquires a noise image is omitted.

For example, in a case where the learning data generation device 100b includes the noise image acquiring unit 151b, the image combining unit 180b pastes the target object-simulated radar image including the shadow pseudo radar image generated by the target object image generating unit 120b to the background image acquired by the background image acquiring unit 140, adds noise to the region of the shadow pseudo radar image in the region to which the target object-simulated radar image is pasted to generate the combined pseudo radar image. More specifically, for example, in this case, the image combining unit 180b adds noise by adding the pixel value of the pixel of the noise image corresponding to each pixel of the region to the pixel value of each pixel of the region of the shadow pseudo radar image in the region at which the target object-simulated radar image has been pasted to the background image.

The image combining unit 180b acquires a position in the background image to which the target object-simulated radar image including the shadow simulated radar image is pasted, for example, on the basis of the operation information output from the operation receiving unit 101. More specifically, for example, the user inputs a position in the background image to which the target object-simulated radar image including the shadow simulated radar image is pasted by operating the input device 50. The operation receiving unit 101 receives an operation signal indicating a position in the background image to which the target object-simulated radar image including the shadow simulated radar image is pasted, converts the operation signal into operation information corresponding to the operation signal, and outputs the converted operation information to the image combining unit 180b. The image combining unit 180b acquires the operation information from the operation receiving unit 101 to acquire the position in the background image to which the target object-simulated radar image including the shadow simulated radar image is pasted.

Furthermore, for example, in a case where the learning data generation device 100b includes the position determination unit 160b, the position to which the target object-simulated radar image including the shadow simulated radar image is pasted may be determined by the position determination unit 160b.

The position determination unit 160b determines the position at which the target object-simulated radar image including the shadow simulated radar image generated by the target object image generating unit 120b is pasted to the background image on the basis of the 3D model of the target object indicated by the target object 3D-model information and the irradiation direction of the simulated radar irradiation to the target object when the target object image generating unit 120b simulates the radar irradiation to the target object using the target object 3D-model information acquired by the 3D model acquiring unit 110.

In addition, the image combining unit 180b may change the size of the target object-simulated radar image including the shadow simulated radar image generated by the target object image generating unit 120b to a predetermined size, paste the target object-simulated radar image including the shadow simulated radar image after the size change to a predetermined position in the background image acquired by the background image acquiring unit 140 to generate a combined pseudo radar image obtained by combining the background image and the target object-simulated radar image including the shadow simulated radar image.

For example, in a case where the learning data generation device 100b includes the size determination unit 170b, the changed size of the target object-simulated radar image including the shadow simulated radar image is determined by the size determination unit 170b.

The size determination unit 170b determines the size of pasting the target object-simulated radar image including the shadow simulated radar image generated by the target object image generating unit 120b to the background image on the basis of the ratio between the distance between the 3D model of the target object indicated by the target object 3D-model information and the emission position of the simulated radar irradiation to the target object when the target object image generating unit 120b simulates the radar irradiation to the target object using the target object 3D-model information acquired by the 3D model acquiring unit 110 and the distance between the assumed target object and the emission position of the radar irradiation in the radar device 10 when the radar device 10 performs actual radar irradiation.

The learning data generating unit 190 generates learning data that associates combined simulated radar image information indicating the combined pseudo radar image generated by the image combining unit 180b with class information indicating the type of the target object. The learning data generating unit 190 may generate the learning data that associates the position at which the image combining unit 180b has pasted the target object-simulated radar image to the background image with the class information indicating the type of the target object.

The embedded coordinate acquiring unit 181b acquires, from the image combining unit 180b, information indicating coordinates of pixels in the background image in which the image combining unit 180b has replaced the pixel value of the background image with the pixel value of the target object-simulated radar image. The embedded coordinate acquiring unit 181b outputs the acquired information to the learning data generating unit 1X). For example, in a case where the learning data generation device 100b includes the embedded coordinate acquiring unit 181b, the learning data generating unit 190 may generate the learning data by associating the coordinates of the pixel in the background image in which the image combining unit 180b has replaced the pixel value of the background image with the pixel value of the target object-simulated radar image with the class information indicating the type of the target object.

Note that each function of the operation receiving unit 101, the 3D model acquiring unit 110, the target object image generating unit 120b, the radar image acquiring unit 130, the background image acquiring unit 140, the noise image acquiring unit 151b, the position determination unit 160b, the size determination unit 170b, the image combining unit 180b, the embedded coordinate acquiring unit 181b, the learning data generating unit 190, and the learning data output unit 199 in the learning data generation device 100b according to the third embodiment may be implemented by the processor 201 and the memory 202 in the hardware configuration illustrated as an example in FIGS. 8A and 8B in the first embodiment, or may be implemented by the processing circuit 203.

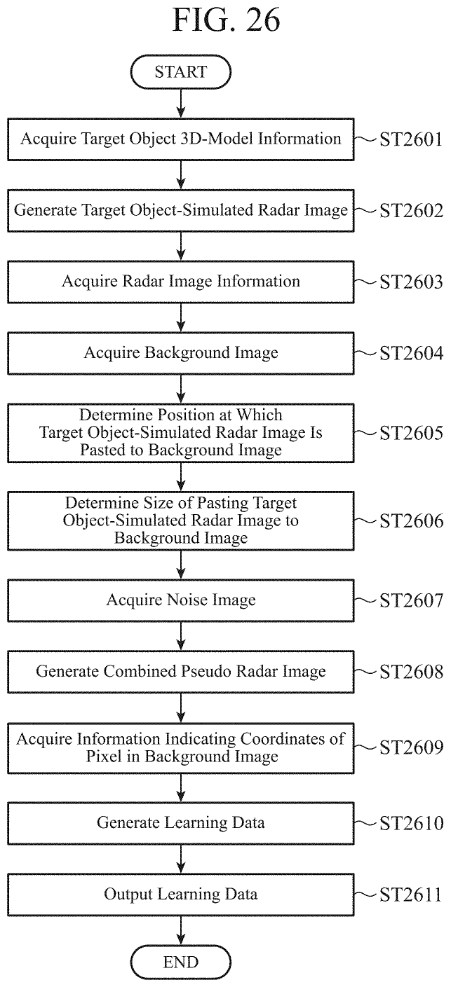

The operation of the learning data generation device 100b according to the third embodiment will be described with reference to FIG. 26.

FIG. 26 is a flowchart illustrating an example of processing of the learning data generation device 100b according to the third embodiment.

For example, the learning data generation device 100b repeatedly executes the processing of the flowchart.

First, in step ST2601, the 3D model acquiring unit 110 acquires target object 3D-model information.

Next, in step ST2602, the target object image generating unit 120b generates a target object-simulated radar image including a shadow simulated radar image.

Next, in step ST2603, the radar image acquiring unit 130 acquires radar image information.

Next, in step ST2604, the background image acquiring unit 140 acquires a background image.

Next, in step ST2605, the position determination unit 160b determines a position at which the target object-simulated radar image including the shadow simulated radar image is pasted to the background image.

Next, in step ST2606, the size determination unit 170b determines the size of pasting the target object-simulated radar image including the shadow simulated radar image to the background image.

Next, in step ST2607, the noise image acquiring unit 151b acquires a noise image.

Next, in step ST2608, the image combining unit 180b generates a combined pseudo radar image.

Next, in step ST2609, the embedded coordinate acquiring unit 181b acquires information indicating coordinates of a pixel in the background image in which the image combining unit 180b has replaced the pixel value of the background image with the pixel value of the target object-simulated radar image.

Next, in step ST2610, the learning data generating unit 190 generates learning data.

Next, in step ST2611, the learning data output unit 199 outputs the learning data.

After executing the processing of step ST2611, the learning data generation device 100b ends the processing of the flowchart, returns to the processing of step ST2601, and repeatedly executes the processing of the flowchart.

Note that, in the processing of the flowchart, if the processing of step ST2601 precedes the processing of step ST2602, the processing of step ST2603 precedes the processing of step ST2604, and the processing from step ST2601 to step ST2604 precedes step ST2605, the order of the processing from step ST2601 to step ST2604 is arbitrary.

Furthermore, in the processing of the flowchart, it is enough that the processing of step ST2607 precedes step ST2608.

Furthermore, in a case where it is not necessary to change the target object 3D-model information when repeatedly executing the processing of the flowchart, the processing of step ST2601 can be omitted.

Furthermore, in a case where it is not necessary to change the radar image information when the processing of the flowchart is repeatedly executed, the processing of step ST2603 can be omitted.

Furthermore, in a case where it is not necessary to change the noise image when the processing of the flowchart is repeatedly executed, the processing of step ST2607 can be omitted.

As described above, the learning data generation device 100b includes the 3D model acquiring unit 110 for acquiring the target object 3D-model information indicating the 3D model of the target object, the target object image generating unit 120b for simulating the radar irradiation to the target object using the target object 3D-model information acquired by the 3D model acquiring unit 110 to generate the target object-simulated radar image that is the simulated radar image of the target object, the radar image acquiring unit 130 for acquiring the radar image information indicating the radar image generated by the radar device 10 performing radar irradiation, the background image acquiring unit 140 for acquiring the background image using the radar image information acquired by the radar image acquiring unit 130, the image combining unit 180b for generating a combined pseudo radar image obtained by combining the background image and the target object-simulated radar image by pasting the target object-simulated radar image generated by the target object image generating unit 120b to a predetermined position in the background image acquired by the background image acquiring unit 140, the learning data generating unit 190 for generating learning data that associates combined simulated radar image information indicating the combined pseudo radar image generated by the image combining unit 180b with class information indicating the type of the target object, and the learning data output unit 199 for outputting the learning data generated by the learning data generating unit 190, and the target object image generating unit 120b is configured to calculate a region to be a radar shadow on the basis of a 3D model of the target object indicated by the target object 3D-model information and an irradiation direction of simulated radar irradiation to the target object, generate a shadow pseudo radar image indicating the calculated region to be the radar shadow, and generate a target object-simulated radar image by including the generated shadow pseudo radar image in the target object-simulated radar image.

With this configuration, the learning data generation device 100b can easily generate learning data used for machine learning for detecting or identifying a target object appearing in a radar image.

Furthermore, with such a configuration, the learning data generation device 100b can generate learning data having a combined pseudo radar image similar to an actual radar image generated by the radar device 10 performing radar irradiation.

Furthermore, with such a configuration, the learning data generation device 100b generates the background image by using the radar image generated by the radar device 10 performing radar irradiation, and thus, it is not necessary to 3D-model the background of the target object.

In addition, since it is not necessary to generate the background image from the 3D model or the like of the background of the target object by numerical calculation, the learning data can be generated in a short time.

Furthermore, in the learning data generation device 100b, in the above-described configuration, the learning data generating unit 190 is configured to generate the learning data that associates the position at which the image combining unit 180b has pasted the target object-simulated radar image to the background image with the class information indicating the type of the target object.

With this configuration, the learning data generation device 100b can easily generate learning data with teacher data used for machine learning for detecting or identifying a target object appearing in a radar image.

In addition, the learning data generation device 100b includes, in addition to the above-described configuration, the embedded coordinate acquiring unit 181b for acquiring information indicating coordinates of a pixel in the background image in which the image combining unit 180b has replaced the pixel value of the background image with the pixel value of the target object-simulated radar image, and the learning data generating unit 190 is configured to generate the learning data by associating the information indicating the coordinates of the pixel in the background image acquired by the embedded coordinate acquiring unit 181b with the class information indicating the type of the target object.

With this configuration, the learning data generation device 100b can easily generate learning data with teacher data used for machine learning for detecting or identifying a target object appearing in a radar image.

In addition, the learning data generation device 100b includes, in addition to the above-described configuration, the noise image acquiring unit 151b for acquiring a noise image for adding noise to a region of a shadow pseudo radar image in the target object-simulated radar image including the shadow pseudo radar image generated by the target object image generating unit 120b, and the image combining unit 180b is configured to paste the target object-simulated radar image including the shadow pseudo radar image generated by the target object image generating unit 120b to the background image, and generate the combined pseudo radar image by adding noise indicated by the noise image acquired by the noise image acquiring unit 151b to the region of the shadow pseudo radar image in the region to which the target object-simulated radar image is pasted.

With this configuration, the learning data generation device 100b can easily generate learning data used for machine learning for detecting or identifying a target object appearing in a radar image.

Furthermore, with such a configuration, the learning data generation device 100b can generate learning data having a combined pseudo radar image similar to an actual radar image generated by the radar device 10 performing radar irradiation.

In addition, the learning data generation device 100b includes, in addition to the above-described configuration, the position determination unit 160b for determining the position at which the target object-simulated radar image including the shadow simulated radar image generated by the target object image generating unit 120b is pasted to the background image on the basis of the 3D model of the target object indicated by the target object 3D-model information and the irradiation direction of the simulated radar irradiation of the target object when the target object image generating unit 120b simulates the radar irradiation to the target object using the target object 3D-model information acquired by the 3D model acquiring unit 110.

With this configuration, the learning data generation device 100b can save the user from inputting the position at which the target object-simulated radar image and the shadow pseudo radar image are pasted to the background image.

In addition, the learning data generation device 100b includes, in addition to the above-described configuration, the size determination unit 170b for determining the size of pasting the target object-simulated radar image including the shadow simulated radar image generated by the target object image generating unit 120b to the background image on the basis of the ratio between the distance between the 3D model of the target object indicated by the target object 3D-model information and the emission position of simulated radar irradiation to the target object when the target object image generating unit 120b simulates the radar irradiation to the target object using the target object 3D-model information acquired by the 3D model acquiring unit 110 and the distance between the assumed target object and the emission position of the radar irradiation in the radar device 10 when the radar device 10 performs actual radar irradiation.

With this configuration, the learning data generation device 100b can save the user from inputting the size of pasting the target object-simulated radar image to the background image.

In addition, in the learning data generation device 100b, in the above-described configuration, the radar image acquiring unit 130 acquires radar image information indicating a radar image in which a wide area is photographed, and the background image acquiring unit 140 cuts out a partial image region of a radar image in which a wide area is photographed indicated by the radar image information acquired by the radar image acquiring unit 130, and acquires the cut out image region as a background image.

With this configuration, the learning data generation device 100b can easily acquire the background image.

It should be noted that the present invention can freely combine the embodiments, modify any constituent element of each embodiment, or omit any constituent element in each embodiment within the scope of the invention.

### INDUSTRIAL APPLICABILITY

The learning data generation device according to the present invention can be applied to a radar system, a learning system, an inference system, or the like.

### REFERENCE SIGNS LIST

1, 1a, 1b: radar system. 2, 2a, 2b: learning system, 3, 3a, 3b: inference system, 10; radar device, 20, 20a: learning device, 21: learning unit, 22: learned model generating unit, 23: learned model output unit, 30, 30a: inference device, 31: inference target radar image acquiring unit, 32: inference unit, 33: inference result output unit, 40: storage device, 50: input device, 60: output device, 100, 100a, 100b: learning data generation device, 101: operation receiving unit, 110: 3D model acquiring unit, 120, 120b: target object image generating unit, 130: radar image acquiring unit, 140: background image acquiring unit, 150: shadow image generating unit, 151, 151b: noise image acquiring unit, 160, 160a, 160b: position determination unit, 170, 170a, 170b: size determination unit, 180, 180a, 180b: image combining unit, 181, 181a, 18b: embedded coordinate acquiring unit, 190: learning data generating unit, 199: learning data output unit, 201: processor, 202: memory, 203: processing circuit

1. A learning data generation device, comprising:
processing circuitry to perform a process of:
acquiring target object 3D-model information indicating a 3D model of a target object;
generating a target object-simulated radar image that is a simulated radar image of the target object by simulating radar irradiation to the target object using the target object 3D-model information acquired;
acquiring radar image information indicating a radar image generated by a radar device performing radar irradiation;
cutting out an image region in which an object of the target object is not appearing from the radar image information acquired and acquiring, as a background image, the image region cut out;
generating a combined pseudo radar image obtained by combining the background image and the target object-simulated radar image by pasting the target object-simulated radar image generated to a predetermined position in the background image acquired
generating learning data that associates combined simulated radar image information indicating the combined pseudo radar image generated with class information indicating a type of the target object; and
outputting the learning data generated.

2. The learning data generation device according to claim 1, wherein
the process generates the learning data that associates a position in the background image, at which the process has pasted the target object-simulated radar image generated to the background image acquired, with the class information indicating a type of the target object.

3. The learning data generation device according to claim 1, further comprising
acquiring information indicating coordinates of a pixel in the background image in which the process has replaced a pixel value of the background image with a pixel value of the target object-simulated radar image, wherein
the process generates the learning data by associating the information indicating coordinates of a pixel in the background image acquired with the class information indicating a type of the target object.

4. The learning data generation device according to claim 1, further comprising
determining a position at which the target object-simulated radar image generated is pasted to the background image, on a basis of a 3D model of the target object indicated by the target object 3D-model information and an irradiation direction of simulated radar irradiation to the target object when the process simulates the radar irradiation to the target object using the target object 3D-model information acquired.

5. The learning data generation device according to claim 1, further comprising
determining a size of pasting the target object-simulated radar image generated to the background image on a basis of a ratio between a distance between a 3D model of the target object indicated by the target object 3D-model information and an emission position of the simulated radar irradiation to the target object when the process simulates the radar irradiation to the target object using the target object 3D-model information acquired, and a distance between an assumed target object and an emission position of radar irradiation in the radar device when the radar device performs actual radar irradiation.

6. The learning data generation device according to claim 1, further comprising
simulating radar irradiation to the target object using the target object 3D-model information acquired, calculating a region to be a radar shadow on a basis of a 3D model of the target object indicated by the target object 3D-model information and an irradiation direction of the simulated radar irradiation to the target object, and generating a shadow simulated radar image indicating the calculated region to be the radar shadow, wherein
the process generates the combined pseudo radar image obtained by combining the background image, the target object-simulated radar image, and the shadow simulated radar image by pasting the target object-simulated radar image generated and the shadow simulated radar image generated to a predetermined position in the background image acquired.

7. The learning data generation device according to claim 6, further comprising
acquiring a noise image for adding noise to the shadow simulated radar image generated, wherein
the process generates the combined pseudo radar image by adding noise indicated by the noise image acquired and further pasting the target object-simulated radar image to a region in which the shadow simulated radar image generated is pasted to the background image acquired.

8. The learning data generation device according to claim 6, further comprising
determining a position at which the target object-simulated radar image generated and the shadow simulated radar image generated are pasted to the background image on a basis of a 3D model of the target object indicated by the target object 3D-model information and the irradiation direction of the simulated radar irradiation to the target object when the process simulates the radar irradiation to the target object using the target object 3D-model information acquired.

9. The learning data generation device according to claim 6, further comprising
determining a size of pasting the target object-simulated radar image generated and the shadow simulated radar image generated to the background image on a basis of a ratio between a distance between a 3D model of the target object indicated by the target object 3D-model information and an emission position of the simulated radar irradiation to the target object when the process simulates radar irradiation to the target object using the target object 3D-model information acquired and a distance between an assumed target object and an emission position of radar irradiation in the radar device when the radar device performs actual radar irradiation.

10. The learning data generation device according to claim 1, wherein
the process, when generating the target object-simulated radar image, calculates a region to be a radar shadow on a basis of a 3D model of the target object indicated by the target object 3D-model information and an irradiation direction of the simulated radar irradiation to the target object, generates a shadow simulated radar image indicating the calculated region to be the radar shadow, and generates the target object-simulated radar image by including the generated shadow simulated radar image in the target object-simulated radar image.

11. The learning data generation device according to claim 10, further comprising
acquiring a noise image for adding noise to a region of the shadow simulated radar image in the target object-simulated radar image including the shadow simulated radar image generated, wherein
the process pastes the target object-simulated radar image including the shadow simulated radar image generated to the background image, and adds noise indicated by the noise image acquired to a region of the shadow simulated radar image in a region to which the target object-simulated radar image has been pasted to generate the combined pseudo radar image.

12. The learning data generation device according to claim 10, further comprising
determining a position at which the target object-simulated radar image including the shadow simulated radar image generated is pasted to the background image on a basis of a 3D model of the target object indicated by the target object 3D-model information and the irradiation direction of the simulated radar irradiation to the target object when the process simulates radar irradiation to the target object using the target object 3D-model information acquired.

13. The learning data generation device according to claim 10, further comprising
determining a size of pasting the target object-simulated radar image including the shadow simulated radar image generated to the background image on a basis of a ratio between a distance between a 3D model of the target object indicated by the target object 3D-model information and an emission position of the simulated radar irradiation to the target object when the process simulates radar irradiation to the target object using the target object 3D-model information acquired and a distance between an assumed target object and an emission position of radar irradiation in the radar device when the radar device performs actual radar irradiation.

14. The learning data generation device according to claim 1, wherein
the process acquires the radar image information indicating the radar image in which a wide area is photographed, and
the process cuts out a partial image region of the radar image in which a wide area is photographed indicated by the radar image information acquired, and acquires the cut out image region as the background image.

15. A learning system comprising:
the learning data generation device according to claim 1; and
a learning device to perform machine learning using the learning data output by the learning data generation device.

16. An inference system comprising:
the learning data generation device according to claim 1;
a learning device to perform machine learning using the learning data output by the learning data generation device; and
an inference device to infer whether an image of the target object is present in the radar image generated by the radar device performing radar irradiation by using a learned model corresponding to a learning result by the machine learning performed by the learning device.

17. A learning data generation method, comprising:
acquiring target object 3D-model information indicating a 3D model of a target object;
simulating radar irradiation to the target object using the target object 3D-model information acquired to generate a target object-simulated radar image that is a simulated radar image of the target object;
acquiring radar image information indicating a radar image generated by a radar device performing radar irradiation;
cutting out an image region in which an object of the target object is not appearing from the radar image information acquired and acquiring, as a background image, the image region cut out;
generating a combined pseudo radar image obtained by combining the background image and the target object-simulated radar image by pasting the target object-simulated radar image generated to a predetermined position in the background image acquired;
generating learning data that associates combined simulated radar image information indicating the combined pseudo radar image generated with class information indicating a type of the target object; and
outputting the learning data generated.

18. A learning data generation program for causing a computer to implement:
acquiring target object 3D-model information indicating a 3D model of a target object;
simulating radar irradiation to the target object using the target object 3D-model information acquired to generate a target object-simulated radar image that is a simulated radar image of the target object;
acquiring radar image information indicating a radar image generated by a radar device performing radar irradiation;
cutting out an image region in which an object of the target object is not appearing from the radar image information acquired and acquiring, as a background image, the image region cut out;
generating a combined pseudo radar image obtained by combining the background image and the target object-simulated radar image by pasting the target object-simulated radar image generated to a predetermined position in the background image acquired
generating learning data that associates combined simulated radar image information indicating the combined pseudo radar image generated with class information indicating a type of the target object; and
outputting the learning data generated b.

19. A learning device comprising:
processing circuitry to perform a process of:
acquiring target object 3D-model information indicating a 3D model of a target object;
generating a target object-simulated radar image that is a simulated radar image of the target object by simulating radar irradiation to the target object using the target object 3D-model information acquired;
acquiring radar image information indicating a radar image generated by a radar device performing radar irradiation;
cutting out an image region in which an object of the target object is not appearing from the radar image information acquired and acquiring, as a background image, the image region cut out;
generating a combined pseudo radar image obtained by combining the background image and the target object-simulated radar image by pasting the target object-simulated radar image generated to a predetermined position in the background image acquired;
generating learning data that associates combined simulated radar image information indicating the combined pseudo radar image generated with class information indicating a type of the target object;
performing machine learning using the learning data generated;
generating learned model information indicating a learned model corresponding to a learning result by the machine learning performed; and
outputting the learned model information generated.

20. A learning method comprising:
acquiring target object 3D-model information indicating a 3D model of a target object;
simulating radar irradiation to the target object using the target object 3D-model information acquired to generate a target object-simulated radar image that is a simulated radar image of the target object;
acquiring radar image information indicating a radar image generated by a radar device performing radar irradiation;
cutting out an image region in which an object of the target object is not appearing from the radar image information acquired and acquiring, as a background image the image region cut out;
generating a combined pseudo radar image obtained by combining the background image and the target object-simulated radar image by pasting the target object-simulated radar image generated to a predetermined position in the background image acquired;
generating learning data that associates combined simulated radar image information indicating the combined pseudo radar image generated with class information indicating a type of the target object;
performing machine learning using the learning data generated;
generating learned model information indicating a learned model corresponding to a learning result by the machine learning performed; and
outputting the learned model information generated.

21. A learning program for causing a computer to implement:
acquiring target object 3D-model information indicating a 3D model of a target object;
simulating radar irradiation to the target object using the target object 3D-model information acquired to generate a target object-simulated radar image that is a simulated radar image of the target object;
acquiring radar image information indicating a radar image generated by a radar device performing radar irradiation;
cutting out an image region in which an object of the target object is not appearing from the radar image information acquired and acquiring, as a background image, the image region cut out;
generating a combined pseudo radar image obtained by combining the background image and the target object-simulated radar image by pasting the target object-simulated radar image generated to a predetermined position in the background image acquired;
generating learning data that associates combined simulated radar image information indicating the combined pseudo radar image generated with class information indicating a type of the target object;
performing machine learning using the learning data generated;
generating learned model information indicating a learned model corresponding to a learning result by the machine learning performed; and
outputting the learned model information generated.

22. An inference device comprising:
processing circuitry to perform a process of:
acquiring target object 3D-model information indicating a 3D model of a target object;
generating a target object-simulated radar image that is a simulated radar image of the target object by simulating radar irradiation to the target object using the target object 3D-model information acquired;
acquiring radar image information indicating a radar image generated by a radar device performing radar irradiation;
cutting out an image region in which an object of the target object is not appearing from the radar image information acquired and acquiring, as a background image, the image region cut out;
generating a combined pseudo radar image obtained by combining the background image and the target object-simulated radar image by pasting the target object-simulated radar image generated to a predetermined position in the background image acquired;
generating learning data that associates combined simulated radar image information indicating the combined pseudo radar image generated with class information indicating a type of the target object;
performing machine learning using the learning data generated;
generating learned model information indicating a learned model corresponding to a learning result by the machine learning performed;
acquiring inference target radar image information indicating the radar image that is an inference target generated by the radar device performing radar irradiation;
inferring whether an image of the target object is present in the radar image indicated by the inference target radar image information acquired by using the learned model indicated by the learned model information generated; and
outputting inference result information indicating an inference result inferred.

23. An inference method comprising:
acquiring target object 3D-model information indicating a 3D model of a target object;
simulating radar irradiation to the target object using the target object 3D-model information acquired to generate a target object-simulated radar image that is a simulated radar image of the target object;
acquiring radar image information indicating a radar image generated by a radar device performing radar irradiation;
cutting out an image region in which an object of the target object is not appearing from the radar image information acquired and acquiring, as a background image, the image region cut out;
generating a combined pseudo radar image obtained by combining the background image and the target object-simulated radar image by pasting the target object-simulated radar image generated to a predetermined position in the background image acquired;
generating learning data that associates combined simulated radar image information indicating the combined pseudo radar image generated with class information indicating a type of the target object;
performing machine learning using the learning data generated;
generating learned model information indicating a learned model corresponding to a learning result by the machine learning performed;
acquiring, inference target radar image information indicating the radar image that is an inference target generated by the radar device performing radar irradiation;
inferring whether an image of the target object is present in the radar image indicated by the inference target radar image information acquired by using the learned model indicated by the learned model information generated; and
outputting inference result information indicating an inference result inferred.

24. An inference program for causing a computer to implement:
acquiring target object 3D-model information indicating a 3D model of a target object;
simulating radar irradiation to the target object using the target object 3D-model information acquired to generate a target object-simulated radar image that is a simulated radar image of the target object;
acquiring radar image information indicating a radar image generated by a radar device performing radar irradiation;
cutting out an image region in which an object of the target object is not appearing from the radar image information acquired and acquiring, as a background image, the image region cut out;
generating a combined pseudo radar image obtained by combining the background image and the target object-simulated radar image by pasting the target object-simulated radar image generated to a predetermined position in the background image acquired;
generating learning data that associates combined simulated radar image information indicating the combined pseudo radar image generated with class information indicating a type of the target object;
performing machine learning using the learning data generated;
generating learned model information indicating a learned model corresponding to a learning result by the machine learning performed;
acquiring inference target radar image information indicating the radar image that is an inference target generated by the radar device performing radar irradiation;
inferring whether an image of the target object is present in the radar image indicated by the inference target radar image information acquired by using the learned model indicated by the learned model information generated; and
outputting inference result information indicating an inference result inferred.
